(19) United States
(12) Patent Application Publication
(10) Pub. No.: US 2025/0317570 A1
(43) Pub. Date: Oct. 9, 2025

(54) SCALING AND REORDERING OF CHAINED MOTION VECTOR PREDICTION FOR VIDEO CODING

(71) Applicant: QUALCOMM Incorporated, San Diego, CA (US)

(72) Inventors: Po-Han Lin, Taipei (TW); Jian-Liang Lin, Su'ao Township (TW); Zhi Zhang, Munich (DE); Vadim Seregin, San Diego, CA (US); Marta Karczewicz, San Diego, CA (US)

(21) Appl. No.: 19/097,134

(22) Filed: Apr. 1, 2025

Related U.S. Application Data
(60) Provisional application No. 63/631,892, filed on Apr. 9, 2024.

(51) Int. Cl. H04N 19/139; H04N 19/132; H04N 19/176; H04N 19/52; H04N 19/70

(52) U.S. Cl. CPC H04N 19/139; H04N 19/132; H04N 19/176; H04N 19/52; H04N 19/70

(57) ABSTRACT

A method of encoding or decoding video data includes determining one or more chained CMVP candidates for a current block of a current picture, comprising: determining a source vector; generating an initial CMVP candidate based on the source vector; and scaling the initial CMVP candidate based on the current picture and a reference picture to generate a CMVP candidate of the one or more CMVP candidates. A method of encoding or decoding video data includes determining one or more CMVP candidates for a current block of a current picture, comprising determining a source vector; scaling the source vector based on the current picture and a reference picture to generate a scaled source vector; and generating a CMVP candidate of the one or more CMVP candidates based on the scaled source vector. The method includes encoding or decoding the current block based on the one or more CMVP candidates.

This application claims the benefit of U.S. Provisional Patent Application No. 63/631,892, filed Apr. 9, 2024, the entire contents of which is incorporated herein by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for chained motion vector prediction (CMVP). In CMVP, for a current block, a video encoder or a video decoder starts with a source vector (e.g., motion or block vector for an adjacent or non-adjacent block in the same picture or motion vector of block of another picture) and inputs that source vector into the CMVP process. The output is a CMVP candidate.

In the CMVP process, a video encoder or video decoder traces vectors, starting with the source vector, of each block identified by an associated vector for a defined trace depth (e.g., a defined number of vectors that are sequentially traced back starting from one block to the last block of the CMVP process), and uses the vectors to determine the CMVP candidate. For instance, the source vector may identify a first block, a first vector (e.g., motion or block vector) for the first block may identify a second block, a second vector for the second block may identify a third block, and so forth. The video encoder and video decoder may utilize the source vector, first vector, second vector, and so forth for the defined trace depth to generate a CMVP candidate. The video encoder and video decoder may repeat such operations for different source vectors to determine one or more CMVP candidates.

In accordance with one or more examples, to generate the CMVP candidates, the video encoder and the video decoder may generate an initial CMVP candidate using the above example techniques of the CMVP process, and then scale the initial CMVP candidate based on the current picture and a reference picture to generate the CMVP candidate. As another example, the video encoder and the video decoder may scale the source vector based on the current picture and a reference picture, and then input the scaled source vector into the CMVP process to generate the CMVP candidate.

With the example scaling, the resulting CMVP candidate may identify a prediction block that approximates the current block better than if no scaling is performed. In this manner, the example techniques may improve the overall video coding technology. For instance, since the prediction block may better approximate the current block, the residual (e.g., difference) between the prediction block and the current block may be relatively small, resulting in less residual information that is signaled and improved bandwidth utilization, and potentially better quality decoded video.

In one example, the disclosure describes a method of encoding or decoding video data, the method comprising: determining one or more chained motion vector prediction (CMVP) candidates for a current block of a current picture, wherein determining the one or more CMVP candidates comprises: determining a source vector; generating an initial CMVP candidate based on the source vector; and scaling the initial CMVP candidate based on the current picture and a reference picture to generate a CMVP candidate of the one or more CMVP candidates; and encoding or decoding the current block based on the one or more CMVP candidates.

In one example, the disclosure describes a method of encoding or decoding video data, the method comprising: determining one or more chained motion vector prediction (CMVP) candidates for a current block of a current picture, wherein determining the one or more CMVP candidates comprises: determining a source vector; scaling the source vector based on the current picture and a reference picture to generate a scaled source vector; and generating a CMVP candidate of the one or more CMVP candidates based on the scaled source vector; and encoding or decoding the current block based on the one or more CMVP candidates.

In one example, the disclosure describes a device for encoding or decoding video data, the device comprising: one or more memories configured to store the video data; and processing circuitry coupled to the one or more memories, wherein the processing circuitry is configured to: determine one or more chained motion vector prediction (CMVP) candidates for a current block of a current picture, wherein to determine the one or more CMVP candidates, the processing circuitry is configured to: determine a source vector; generate an initial CMVP candidate based on the source vector; and scale the initial CMVP candidate based on the current picture and a reference picture to generate a CMVP candidate of the one or more CMVP candidates; and encode or decode the current block based on the one or more CMVP candidates.

In one example, the disclosure describes a device for encoding or decoding video data, the device comprising: one or more memories configured to store the video data; and processing circuitry coupled to the one or more memories, wherein the processing circuitry is configured to: determine one or more chained motion vector prediction (CMVP) candidates for a current block of a current picture, wherein to determine the one or more CMVP candidates, the processing circuitry is configured to: determine a source vector; scale the source vector based on the current picture and a reference picture to generate a scaled source vector; and generate a CMVP candidate of the one or more CMVP candidates based on the scaled source vector; and encode or decode the current block based on the one or more CMVP candidates.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a block diagram illustrating an example video encoder that may perform the techniques of this disclosure.

FIG. 3 is a block diagram illustrating an example video decoder that may perform the techniques of this disclosure.

FIG. 4 is a flowchart illustrating an example method for encoding a current block in accordance with the techniques of this disclosure.

FIG. 5 is a flowchart illustrating an example method for decoding a current block in accordance with the techniques of this disclosure.

FIGS. 6A and 6B are conceptual diagrams illustrating examples of spatial neighboring blocks for motion vector candidates for merge mode and advanced motion vector prediction (AMVP) mode, respectively.

FIG. 7A is a conceptual diagram illustrating an example of a temporal motion vector predictor (TMVP).

FIG. 7B is a conceptual diagram illustrating an example of motion vector (MV) scaling.

FIG. 8 is a conceptual diagram illustrating an example of template matching on a search area around an initial MV.

FIG. 9 is a conceptual diagram illustrating an example of motion vector differences that are proportional based on temporal distances.

FIG. 10 is a conceptual diagram illustrating an example of motion vector differences that are mirrored regardless of temporal distances.

FIG. 11 is a conceptual diagram illustrating an example 3×3 square search pattern in the search range [−8, 8].

FIG. 12 is a conceptual diagram illustrating decoding side motion vector refinement.

FIG. 13 is a conceptual diagram illustrating an example of derivation of a chained motion vector prediction (CMVP) candidate.

FIG. 14 is a conceptual diagram illustrating an example operation of referencing source and destination of tracking motion vectors in CMVP.

FIG. 15 is a conceptual diagram illustrating an example of CMVP motions with trace depth one.

FIG. 16 is a flowchart illustrating an example method of encoding or decoding video data.

FIG. 17 is a flowchart illustrating another example method of encoding or decoding video data.

### DETAILED DESCRIPTION

For certain video coding modes, a video encoder and a video decoder determine a vector (e.g., motion vector or block vector). The vector identifies a prediction block (e.g., prediction signal). The video encoder determines a residual between the prediction signal and the current block, and signals the residual information. The video decoder receives the residual information, and adds the residual to the prediction signal to reconstruct the current block.

The video encoder and the video decoder may each construct a list of vector candidates. The video encoder may signal, and the video decoder may receive an index into the list of vector candidates. The video decoder may determine the vector based on the index.

The video encoder and the video decoder may populate the list of vector candidates using various techniques, including chained motion vector prediction (CMVP) candidates. A CMVP candidate may be a vector that the video encoder and the video decoder determine by tracing associated vectors of blocks for a defined trace depth. For instance, as described above, the video encoder and the video decoder may start with a source vector (e.g., vector of a block in same picture or vector of co-located block in another picture). The video encoder and the video decoder may identify a first block based on the source vector, identify a second block based on a first vector of the first block, identify a third block based on a second vector of the second block, and so forth. The video encoder and video decoder may utilize the source vector, first vector, second vector, and so forth for the defined trace depth to generate a CMVP candidate. The video encoder and video decoder may repeat such operations for different source vectors to determine one or more CMVP candidates. The video encoder and the video decoder may include one or more of the CMVP candidates in the list of vector candidates.

In some cases, because the video encoder and the video decoder may determine the CMVP candidate through a chained process, it may be possible for the CMVP candidate to be suboptimal if distances between pictures are not accounted for. That is, the CMVP candidate may identify a candidate prediction block that does not adequately approximate the current block as compared to if distances between pictures are accounted for.

In one or more examples, the video encoder and the video decoder may determine an initial CMVP candidate using the above techniques of a CMVP process, and then scale the initial CMVP candidate based on a current picture that includes the current block and a reference picture to generate the CMVP candidate. In one or more examples, the video encoder and the video decoder may scale the source vector based on a current picture that includes the current block and a reference picture to generate a scaled source vector. The video encoder and the video decoder may input the scaled source vector into the CMVP process to generate a CMVP candidate.

The video encoder and the video decoder may repeat any of the above example techniques with different source vectors to generate one or more CMVP candidates. In some examples, the video encoder and the video decoder may order the CMVP candidates in the list of vector candidates based on the template matching costs of each of the CMVP candidates.

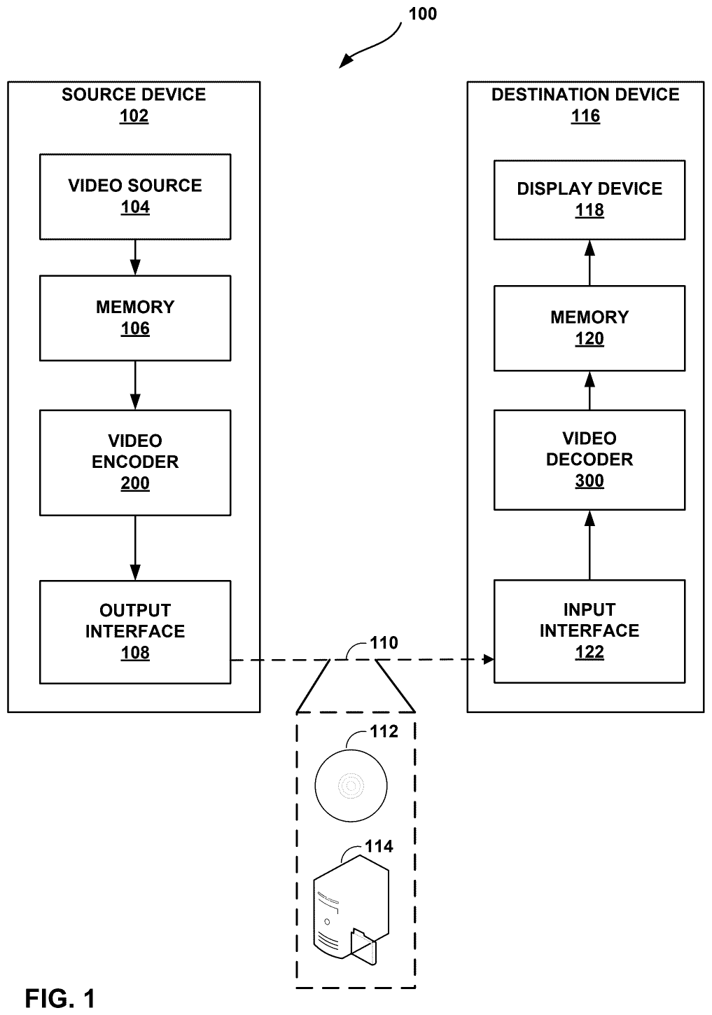

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for chained motion vector prediction (CMVP). Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for CMVP. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally, or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder (e.g., audio codec), and may include appropriate MUX-DEMUX units, or other hardware and/or software, to handle multiplexed streams including both audio and video in a common data stream. Example audio codecs may include AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB). G.723.1, G.726, G.728, G.729, G.729.1, GSM-FR, HE-AAC, iLBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, True Audio (TTA), TwinVQ, USAC, Vorbis (Ogg), WavPack, and Windows Media Aud.

Video encoder 200 and video decoder 300 each may be implemented as any of a variety of suitable encoder and/or decoder circuitry that includes a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format.

In general, video encoder 200 and video decoder 300 may be configured to perform the techniques of this disclosure in conjunction with any video coding techniques that use CMVP. In one or more examples, video encoder 200 and video decoder 300 may determine an initial CMVP candidate using a CMVP process, and then scale the initial CMVP candidate based on a current picture that includes a current block and a reference picture to generate the CMVP candidate. In one or more examples, the video encoder and the video decoder may scale the source vector based on a current picture that includes the current block and a reference picture to generate a scaled source vector. The video encoder and the video decoder may input the scaled source vector into the CMVP process to generate a CMVP candidate. The CMVP process may include tracing vectors for corresponding blocks staring from a source vector or scaled source vector, and using the vectors to determine a vector for the current block.

Video encoder 200 and video decoder 300 may repeat any of the above example techniques with different source vectors to generate one or more CMVP candidates. In some examples, video encoder 200 and video decoder 300 may order the CMVP candidates in the list of vector candidates based on the template matching costs of each of the CMVP candidates.

Video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

As described above, video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multi-view Video Coding (MVC) extensions.

In addition, a video coding standard, namely High Efficiency Video Coding (HEVC) or ITU-T H.265, including its range extension, multiview extension (MV-HEVC) and scalable extension (SHVC), has been developed by the Joint Collaboration Team on Video Coding (JCT-VC) as well as Joint Collaboration Team on 3D Video Coding Extension Development (JCT-3V) of ITU-T Video Coding Experts Group (VCEG) and ISO/IEC Motion Picture Experts Group (MPEG).

ITU-T VCEG (Q6/16) and ISO/IEC MPEG (JTC 1/SC 29/WG 11) studied the potential need for standardization of future video coding technology with a compression capability that significantly exceeds that of the current HEVC standard (including its current extensions and near-term extensions for screen content coding and high-dynamic-range coding). The groups worked this exploration activity in a joint collaboration effort known as the Joint Video Exploration Team (JVET) to evaluate compression technology designs proposed by their experts in this area. The Versatile Video Coding (VVC) draft specification could be referred to JVET-T2001. Algorithm description of Versatile Video Coding and Test Model 10 (VTM 10.0) could be referred to JVET-T2002.

The following describes a CU structure and motion vector prediction in HEVC. In HEVC, the largest coding unit in a slice is called a coding tree block (CTB) or coding tree unit (CTU). A CTB contains a quad-tree the nodes of which are coding units.

The size of a CTB can be ranges from 16×16 to 64×64 in the HEVC main profile (although technically 8×8 CTB sizes can be supported). A coding unit (CU) could be the same size of a CTB to as small as 8×8. Each coding unit is coded with one mode, i.e. inter or intra. When a CU is inter coded, the CU may be further partitioned into 2 or 4 prediction units (PUs) or become just one PU when further partition does not apply. When two PUs are present in one CU, the two PUs can be half size rectangles or two rectangle size with ¼ or ¾ size of the CU.

When the CU is inter coded, each PU has one set of motion information, which is derived with a unique inter prediction mode.

For motion vector prediction, in HEVC standard, there are two inter prediction modes, named merge (skip is considered as a special case of merge) and advanced motion vector prediction (AMVP) modes respectively for a prediction unit (PU). In either AMVP or merge mode, a motion vector (MV) candidate list (e.g., list of vector candidates) is maintained for multiple motion vector predictors. The motion vector(s), as well as reference indices in the merge mode, of the current PU are generated by taking one candidate from the MV candidate list.

The MV candidate list (also called list of vector candidates) may contain up to 5 candidates for the merge mode and only two candidates for the AMVP mode. A merge candidate may contain a set of motion information, e.g., motion vectors corresponding to both reference picture lists (list 0 and list 1) and the reference indices. If a merge candidate is identified by a merge index, the reference pictures used for the prediction of the current blocks, as well as the associated motion vectors are determined. On the other hand, under AMVP mode for each potential prediction direction from either list 0 or list 1, a reference index needs to be explicitly signaled, together with an MV predictor (MVP) index to the MV candidate list since the AMVP candidate contains only single a motion vector. In AMVP mode, the predicted motion vectors can be further refined. The candidates for both modes are derived similarly from the same spatial and temporal neighboring blocks.

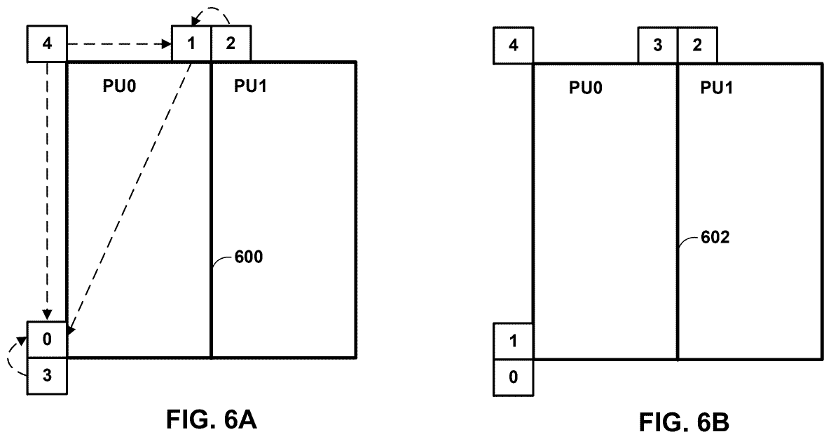

The following describes spatial neighboring candidates. Spatial MV candidates are derived from the neighboring blocks shown on FIGS. 6A and 6B, for a specific PU (PU0) 600 for FIG. 6A and PU0 602 for FIG. 6B, although the methods generating the candidates from the blocks differ for merge and AMVP modes.

In merge mode, up to four spatial MV candidates can be derived with the orders shown in FIG. 6A with numbers, and the order is the following: left (0, A1), above (1, B1), above right (2, B0), below left (3, A0), and above left (4, B2), as shown in FIG. 6A

In AVMP mode, the neighboring blocks are divided into two groups: left group consisting of the block 0 and 1, and above group consisting of the blocks 2, 3, and 4 as shown in FIG. 6B. For each group, the potential candidate in a neighboring block referring to the same reference picture as that indicated by the signaled reference index has the highest priority to be chosen to form a final candidate of the group. It is possible that all neighboring blocks do not contain a motion vector pointing to the same reference picture. Therefore, if such a candidate cannot be found, the first available candidate will be scaled to form the final candidate, thus the temporal distance differences can be compensated.

The following describes temporal motion vector prediction in HEVC. Temporal motion vector predictor (TMVP) candidate, if enabled and available, is added into the MV candidate list after spatial motion vector candidates. The process of motion vector derivation for TMVP candidate is the same for both merge and AMVP modes, however the target reference index for the TMVP candidate in the merge mode is always set to 0.

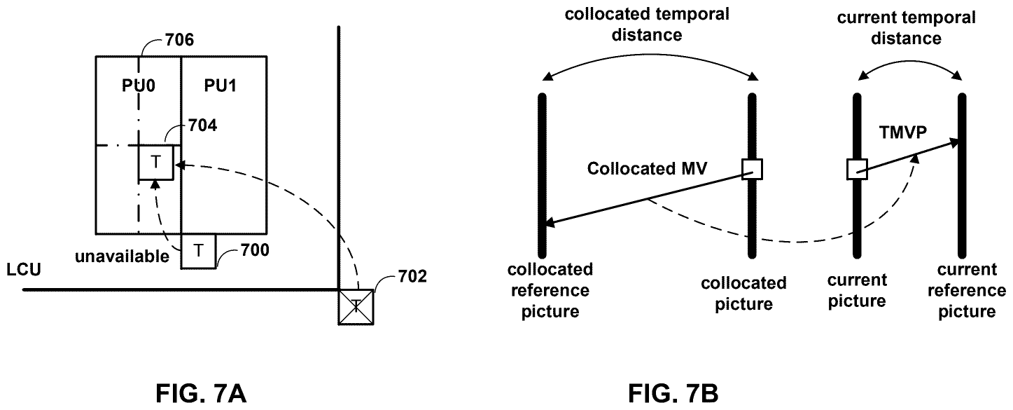

The primary block location for TMVP candidate derivation is the bottom right block outside of the collocated PU as shown in FIG. 7A as a block “T”, to compensate the bias to the above and left blocks used to generate spatial neighboring candidates. However, if that block is located outside of the current CTB row or motion information is not available, the block is substituted with a center block of the PU.

Motion vector for TMVP candidate is derived from the co-located PU of the co-located picture, indicated in the slice level. The motion vector for the co-located PU is called collocated MV. Similar to temporal direct mode in AVC, to derive the TMVP candidate motion vector, the co-located MV may be scaled to compensate the temporal distance differences, as shown in FIG. 7B.

The following are other aspects of motion prediction in HEVC. For instance, the following are several aspects of merge and AMVP modes.

Motion vector scaling: It is assumed that the value of motion vectors is proportional to the distance of pictures in the presentation time. A motion vector associates two pictures, the reference picture, and the picture containing the motion vector (namely the containing picture). When a motion vector is utilized to predict the other motion vector, the distance of the containing picture and the reference picture is calculated based on the Picture Order Count (POC) values.

For a motion vector to be predicted, both its associated containing picture and reference picture may be different. Therefore, a new distance (based on POC) is calculated. And the motion vector is scaled based on these two POC distances. For a spatial neighboring candidate, the containing pictures for the two motion vectors are the same, while the reference pictures are different. In HEVC, motion vector scaling applies to both TMVP and AMVP for spatial and temporal neighboring candidates.

Artificial motion vector candidate generation: If a motion vector candidate list is not complete, artificial motion vector candidates are generated and inserted at the end of the list until it will have all candidates.

In merge mode, there are two types of artificial MV candidates: combined candidate derived only for B-slices and zero candidates used only for AMVP if the first type does not provide enough artificial candidates.

For each pair of candidates that are already in the candidate list and have necessary motion information, bi-directional combined motion vector candidates are derived by a combination of the motion vector of the first candidate referring to a picture in the list 0 and the motion vector of a second candidate referring to a picture in the list 1.

Pruning process for candidate insertion: Candidates from different blocks may happen to be the same, which decreases the efficiency of a merge/AMVP candidate list. A pruning process is applied to solve this problem. It compares one candidate against the others in the current candidate list to avoid inserting identical candidate in certain extent. To reduce the complexity, only limited numbers of pruning process is applied instead of comparing each potential one with all the other existing ones.

The following describes template matching prediction. Template matching (TM) prediction is a special merge mode based on Frame-Rate Up Conversion (FRUC) techniques. With this mode, motion information of a block is not signaled but derived at decoder side. It is applied to both AMVP mode and regular merge mode. In AMVP mode, MVP candidate selection is determined based on template matching to pick up the one which reaches the minimal difference between current block template and reference block template. In regular merge mode, a TM mode flag is signaled to indicate the use of TM and then TM is applied to the merge candidate indicated by merge index for MV refinement.

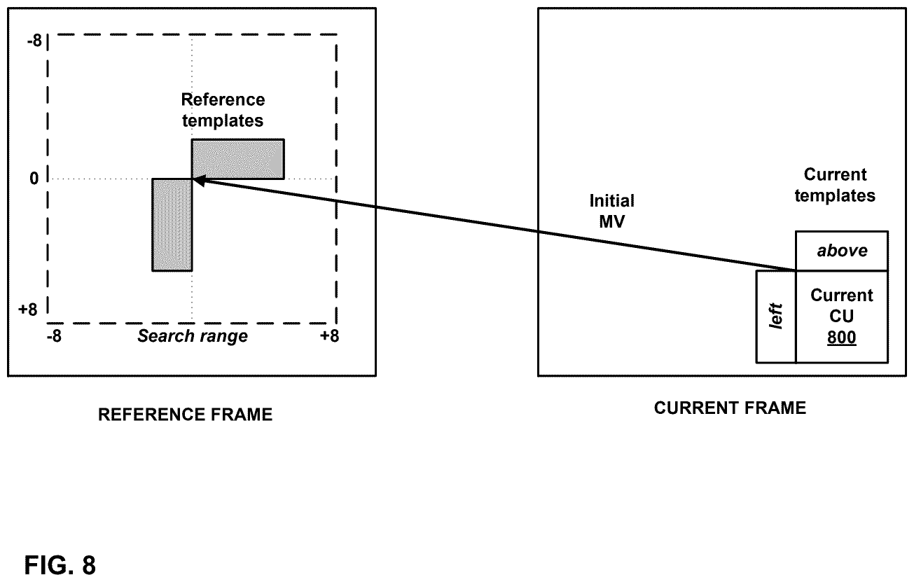

As shown in FIG. 8, template matching is used to derive motion information of the current CU 800 by finding the closest match between a template (top and/or left neighboring blocks of the current CU) in the current picture and a block (same size to the template) in a reference picture. With an AMVP candidate selected based on initial matching error, the MVP of the AMVP candidate is refined by template matching. With a merge candidate indicated by signaled merge index, the merged MVs corresponding to reference picture list 0 (L0) and reference picture list 1 (L1) are refined independently by template matching and then the less accurate one is further refined again with the better one as a prior. Reference picture list 0 and reference picture list 1 may be examples of a list of reference pictures that can potentially be used for inter-prediction.

Cost function: When a motion vector points to a fractional sample position, motion compensated interpolation may be needed. To reduce complexity, bi-linear interpolation instead of regular 8-tap DCT-IF interpolation is used for both template matching to generate templates on reference pictures. The matching cost C of template matching is calculated as follows:

C=SAD+w·(|MVₓ−MVₓ^{z}|+|MV_{y}−MV_{y}^{s}|)
where w is a weighting factor which is empirically set to 4, MV and MV^{s} indicate the currently testing MV and the initial MV (i.e., an MVP candidate in AMVP mode or merged motion in merge mode), respectively. SAD is used as the matching cost of template matching.

When TM is used, motion is refined by using luma samples only. The derived motion will be used for both luma and chroma for MC inter prediction. After MV is decided, final MC is performed using 8-taps interpolation filter for luma and 4-taps interpolation filter for chroma.

Search method: MV refinement is a pattern based MV search with the criterion of template matching cost. Two search patterns are supported—a diamond search and a cross search for MV refinement. The MV is directly searched at quarter luma sample MVD accuracy with diamond pattern, followed by quarter luma sample MVD accuracy with cross pattern, and then this is followed by one-eighth luma sample MVD refinement with cross pattern. The search range of MV refinement is set equal to (−8, +8) luma samples around the initial MV.

The following describes bilateral matching prediction. Bilateral Matching (a.k.a., Bilateral Merge) (BM) prediction is another merge mode base on Frame-Rate Up Conversion (FRUC) techniques. When a block is determined to apply the BM mode, two initiate (e.g., initial) motion vectors MV0 and MV1 are derived by using a signaled merge candidate index to select the merge candidate in a constructed merge list. Video encoder 200 and video decoder 300 may perform bilateral matching search around the MV0 and MV1. The final MV0′ and MV1′ are derived based on the minimum Bilateral Matching cost.

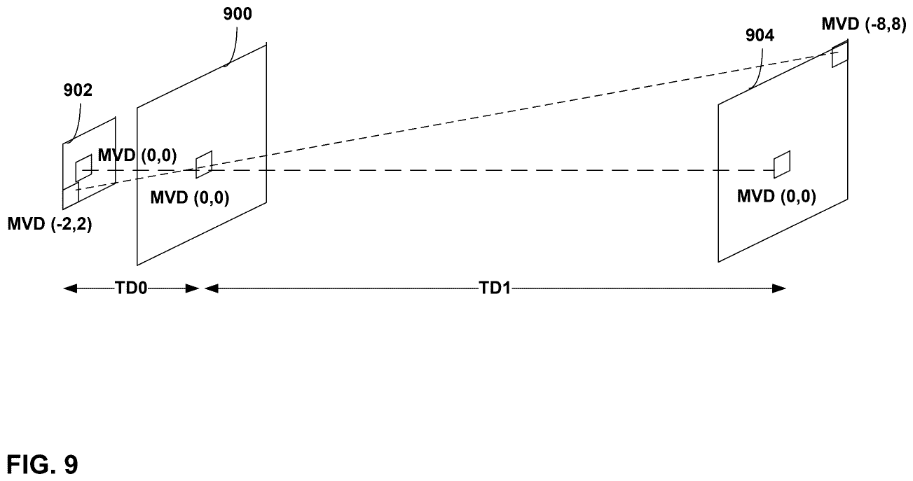

The motion vector difference MVD0 (denoted by MV0′−MV0) and MVD1 (denoted by MV1′−MV1) pointing to the two reference blocks may be proportional to the temporal distances (TD), e.g. TD0 and TD1, between the current picture 900 and the two reference pictures 902, 904. FIG. 9 shows an example of MVD0 and MVD1 wherein, the TD1 is 4 times of TD0.

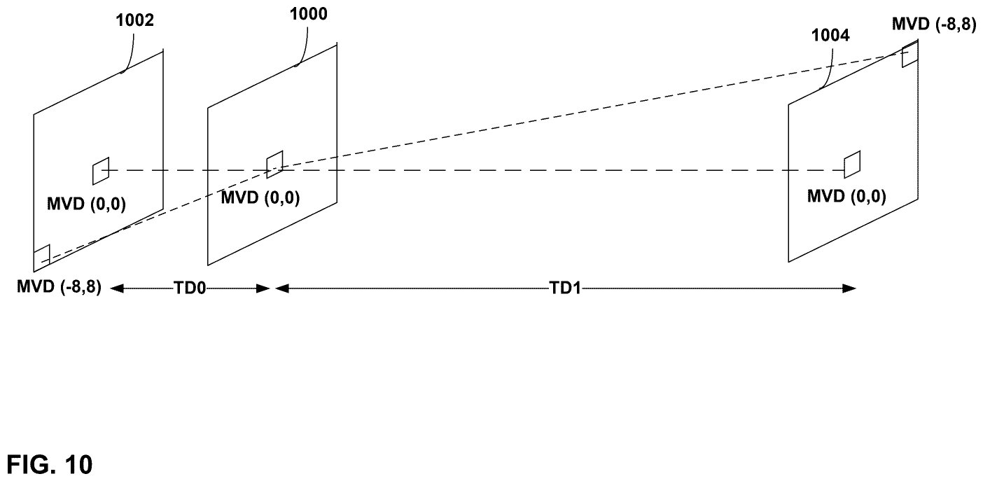

However, there is an optional design where MVD0 and MVD1 are mirrored regardless of the temporal distances TD0 and TD1. FIG. 10 shows an example of mirrored MVD0 and MVD1 regardless of the temporal distances TD0 and TD1, between the current picture 1000 and the two reference pictures 1002, 1004 where, the TD1 is 4 times of TD0.

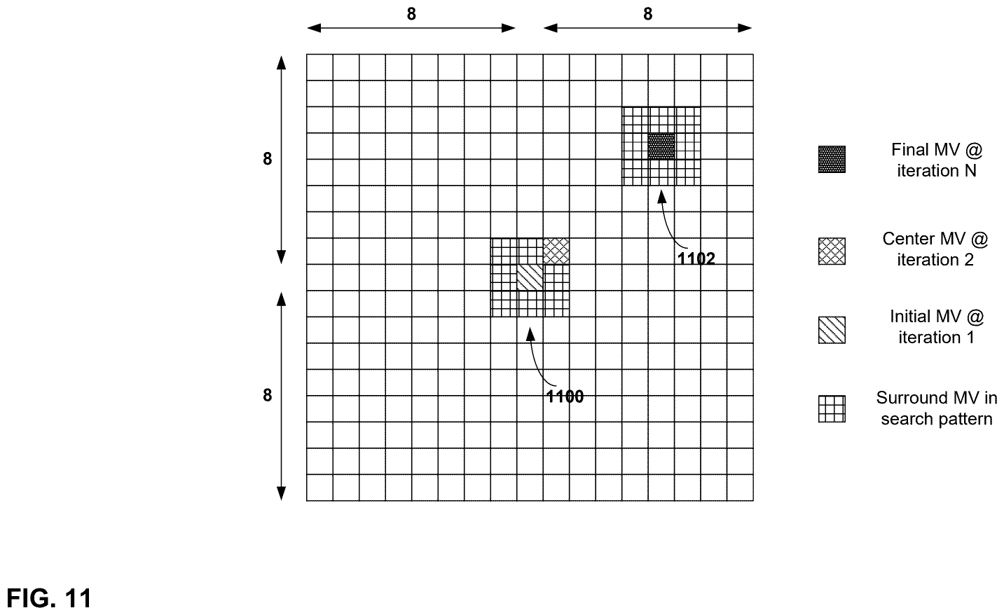

For bilateral matching, video encoder 200 and video decoder 300 may perform a local search around the initial MV0 and MV1 to derive the final MV0′ and MV1′. The local search applies a 3×3 square search pattern to loop through the search range [−8, 8]. In each search iteration, the bilateral matching cost of the eight surrounding MVs in the search pattern are calculated and compared to the bilateral matching cost of center MV. The MV which has minimum bilateral matching cost becomes the new center MV in the next search iteration. The local search is terminated when the current center MV has a minimum cost within the 3×3 square search pattern or the local search reaches the pre-defined maximum search iteration. FIG. 11 shows examples of the 3×3 square search patterns 1100, 1102 in the search range [−8, 8].

The following describes bilateral matching for AMVP-merge mode. The bi-directional predictor is composed of an AMVP predictor in one direction and a merge predictor in the other direction. The mode can be enabled to a coding block when the selected merge predictor and the AMVP predictor satisfy DMVR (decoder-side motion vector refinement) condition(s), where there is at least one reference picture from the past and one reference picture from the future relative to the current picture and the distances from two reference pictures to the current picture are the same, the bilateral matching MV refinement is applied for the merge MV candidate and AMVP MVP as a starting point. Otherwise, if template matching functionality is enabled, template matching MV refinement is applied to the merge predictor or the AMVP predictor which has a higher template matching cost.

AMVP may is signaled as a regular uni-directional AMVP, i.e. reference index and MVD are signaled, and it has a derived MVP index if template matching is used or an MVP index is signaled when template matching is disabled.

For AMVP direction LX, X can be 0 or 1, the merge part in the other direction (1-LX) is implicitly derived by minimizing the bilateral matching cost between the AMVP predictor and a merge predictor, e.g., for a pair of the AMVP and a merge motion vectors. For every merge candidate in the merge candidate list which has that other direction (1-LX) motion vector, the bilateral matching cost is calculated using the merge candidate MV and the AMVP MV The merge candidate with the smallest cost is selected. The bilateral matching refinement is applied to the coding block with the selected merge candidate MV and the AMVP MV as a starting point.

The third pass of multi pass DMVR which is sub-PU BDOF refinement of the multi-pass DMVR is enabled to AMVP-merge mode coded block. Sub-PU size of BDOF is adaptively selected depending on the width×height. For blocks smaller than 256, subblock size of 4×4, and otherwise 8×8 is used. In addition, the following high-precision equations to derive the BDOF MV refinement parameters are utilized:

ΣGx·Gx*vx+ΣGx·Gy*vy=ΣdI·Gx→s1*vx+s2*vy=s3

ΣGx·Gy*vx+ΣGy·Gy*vy=ΣdI·Gy→s2*vx+s5*vy=s6

where Gx/Gy are the summation of the 2 horizontal/vertical gradients derived for each reference block.

Summations (Σ) are weighted sums, where weights depend on the position in the target region Ω. The weights can also be applied to derive vx/vy in other cases.

The mode is indicated by a flag, if the mode is enabled, an AMVP direction LX is further indicated by a flag.

When bilateral matching (BM) AMVP-merge mode is used for the current block and template matching is enabled, MVD is not signaled. An additional pair of AMVP-merge MVPs is introduced. The merge candidate list is sorted based on the BM cost in increasing order. An index (0 or 1) is signaled to indicate which merge candidate in the sorted merge candidate list to use. When there is only one candidate in merge candidate list, the pair of AMVP MVP and merge MVP without bilateral matching MV refinement is padded.

The following describes adaptive decoder-side motion vector refinement (DMVR). Adaptive decoder side motion vector refinement method is an extension of multi-pass DMVR which consists of the two new merge modes to refine MV only in one direction, either L0 or L1, of the bi-prediction for the merge candidates that meet the DMVR conditions. The multi-pass DMVR process is applied for the selected merge candidate to refine the motion vectors, however either MVD0 or MVD1 is set to zero in the 1st pass (i.e., PU level) DMVR.

The merge candidates for the new merge mode are derived from spatial neighboring coded blocks, TMVPs, non-adjacent blocks, history-based motion vector predictors (HMVPs), pair-wise candidate, similar as in the regular merge mode. The difference is that only those that meet DMVR conditions are added into the candidate list. The same merge candidate list is used by the two new merge modes. If the list of BM candidates contains the inherited BCW weights and DMVR process is unchanged except the computation of the distortion is made using MRSAD or MRSATD if the weights are non-equal and the bi-prediction is weighted with BCW weights. Merge index is coded as in regular merge mode.

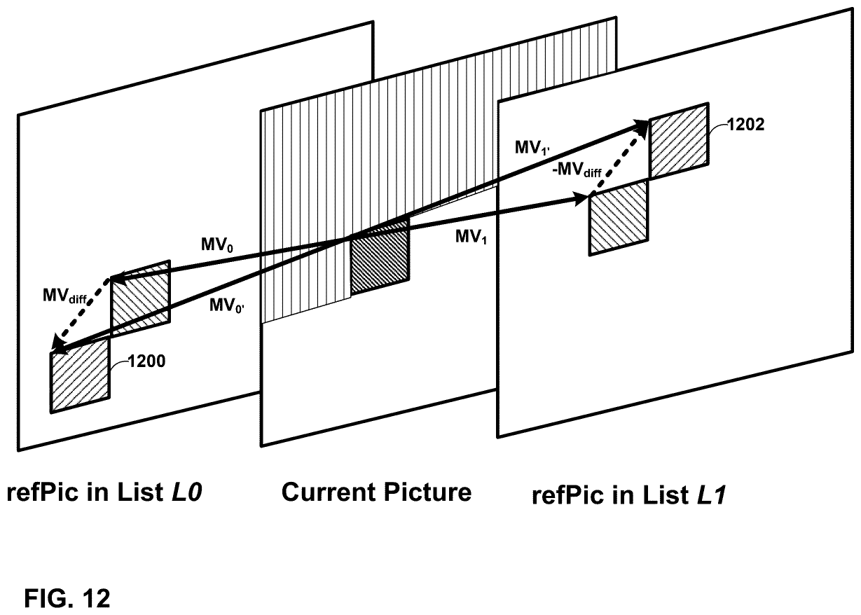

The following describes decoder-side motion vector refinement. To increase the accuracy of the MVs of the merge mode, a decoder side motion vector refinement (DMVR) is applied in VVC. In bi-prediction operation, a refined MV is searched around the initial MVs in the reference picture list L0 and reference picture list L1. The DMVR method calculates the distortion between the two candidate blocks in the reference picture list L0 and list L1. As illustrated in FIG. 12, the SAD between the blocks 1200 and 1202 based on each MV candidate around the initial MV is calculated. The MV candidate with the lowest SAD becomes the refined MV and used to generate the bi-predicted signal.

The refined MV derived by DMVR process is used to generate the inter prediction samples and also used in temporal motion vector prediction for future pictures coding. While the original MV is used in deblocking process and also used in spatial motion vector prediction for future CU coding.

DMVR is a sub-block based merge mode with a pre-defined maximum processing unit of 16×16 luma samples. When the width and/or height of a CU are larger than 16 luma samples, it will be further split into subblocks with width and/or height equal to 16 luma samples.

The following describes examples of a searching scheme. In DVMR, the search points are surrounding the initial MV and the MV offset obey the MV difference mirroring rule. In other words, any points that are checked by DMVR, denoted by candidate MV pair (MV0, MV1) obey the following two equations:

$$MV {0}^{′} = MV 0 + MV\_offset$$

$$MV {1}^{′} = MV 1 - MV\_offset$$

where MV_offset represents the refinement offset between the initial MV and the refined MV in one of the reference pictures. The refinement search range is two integer luma samples from the initial MV. The searching includes the integer sample offset search stage and fractional sample refinement stage.

A 25-point full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, the original MV may be favored during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form

$$E ( x , y ) = {A ( x - {x}_{min} )}^{2} + {B ( y - {y}_{min} )}^{2} + C$$

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

$${x}_{min} = ( E ( - 1 , 0 ) - E ( 1 , 0 ) ) / ( 2 ( E ( - 1 , 0 ) + E ( 1 , 0 ) - 2 E ( 0 , 0 ) ) )$$

$${y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) )$$

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ, yₘᵢₙ) are added to the integer distance refinement MV to get the sub-pixel accurate refinement delta MV.

The following describes bilinear-interpolation and sample padding. In VVC, the resolution of the MVs is 1/16 luma samples. The samples at the fractional position are interpolated using an 8-tap interpolation filter. In DMVR, the search points are surrounding the initial fractional-pel MV with an integer sample offset, therefore the samples of those fractional position need to be interpolated for DMVR search process. To reduce the calculation complexity, the bi-linear interpolation filter is used to generate the fractional samples for the searching process in DMVR. Another effect is that by using bi-linear filter is that with 2-sample search range, the DVMR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

The following describes some examples of enabling condition for when DMVR is enabled. DMVR is enabled if the following conditions are satisfied (e.g., all satisfied):
a. CU level merge mode with bi-prediction MV
b. One reference picture is in the past and another reference picture is in the future with respect to the current picture
c. The distances (i.e. POC difference) from both reference pictures to the current picture are same
d. CU has more than 64 luma samples
e. Both CU height and CU width are larger than or equal to 8 luma samples
f. BCW weight index indicates equal weight
g. WP is not enabled for the current block, and/or
h. CIIP mode is not used for the current block

The following describes chained mirror vector prediction. Chained MV prediction (CMVP) is a technique to derive the merge candidates in the inter merge candidate list construction.

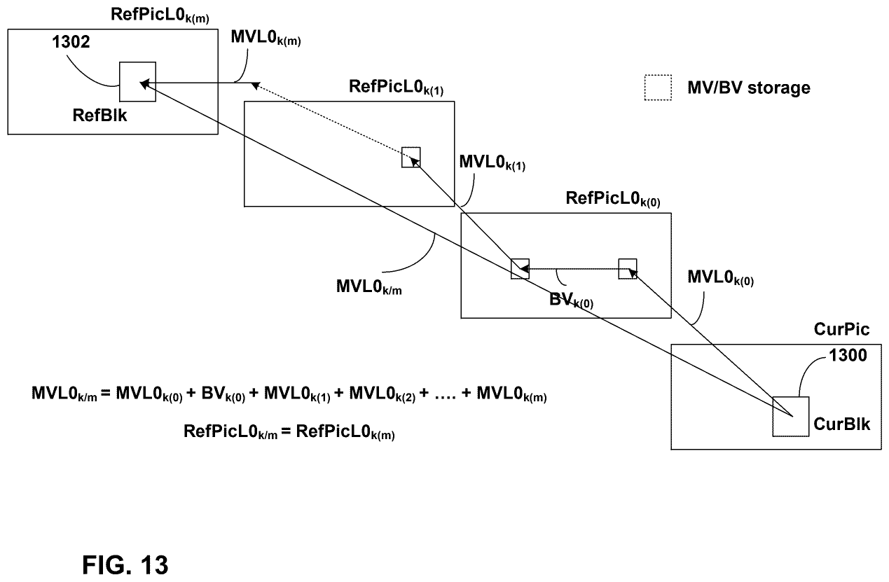

As shown in FIG. 13, CMVP candidates for current block 1300 in the current picture can be derived as the accumulation of the recursively traced MVs (motion vectors) and/or BVs (block vectors) based on the pre-derived MVs (e.g., source vectors) for the inter merge candidate list. For instance, a CMVP candidate, a set of motion vector MV_{k/m} and reference picture RefPic_{k/m} can be derived by

$${MV}_{k / m} = {MV}_{k ( 0 )} + {BV}_{k ( 0 )} + {MV}_{k ( 1 )} + {MV}_{k ( 2 )} + … + {MV}_{k ( m )} ,$$

$${RefPic}_{k / m} = {RefPick}_{k ( m )} ,$$

where k and m indicate the number of merge index and trace depths of the CMVP. In FIG. 13, reference block 1302 is pointed to by motion vector MVL0_{k/m}.

In FIG. 13, video encoder 200 or video decoder 300 may accumulate recursively traced motion vectors or block vectors for a trace depth starting from the source vector. In this example, each of the traced motion vectors or block vectors is a motion vector or block vector for a block pointed to by a previous motion vector or block vector of the traced motion vectors or block vectors.

For example, as illustrated in FIG. 13, MVL0ₖ₍₀₎ may be the source vector, and MVL0_{k/m} may be the CMVP candidate. Also, as can be seen in FIG. 13, MVL0ₖ₍₁₎ is a motion vector or block vector for a block that is pointed to by a previous motion vector or block vector (e.g., MVL0ₖ₍₀₎) of the traced motion vectors or block vectors. In this example, the traced motion vectors include MVL0ₖ₍₀₎+BVₖ₍₀₎+MVL0ₖ₍₁₎+MVL0ₖ₍₂₎+ . . . +MVL0ₖ₍ₘ₎. In this example, the trace depth is two, and the recursive accumulation may be MVL0_{k/m}=MVL0ₖ₍₀₎+BVₖ₍₀₎+MVL0ₖ₍₁₎+MVL0ₖ₍₂₎+ . . . +MVL0ₖ₍ₘ₎.

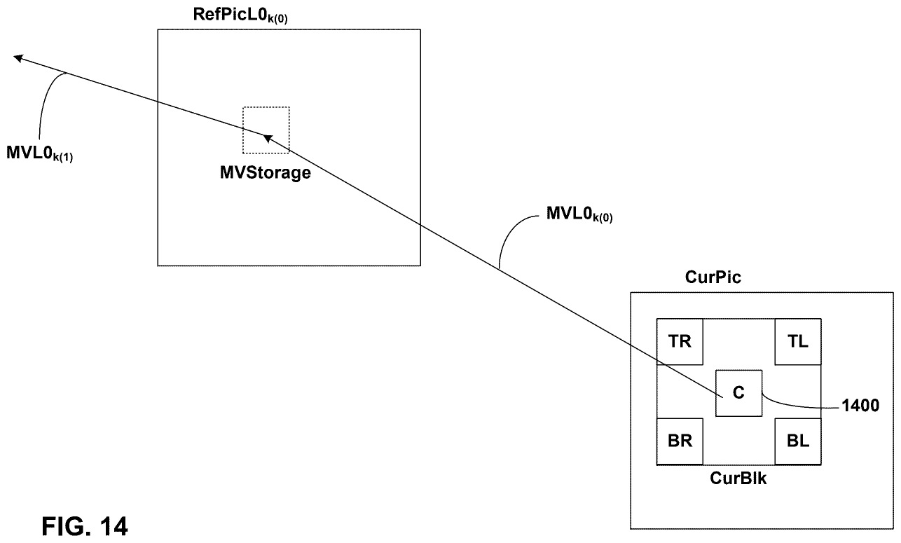

When deriving MV_{k/m}, MVₖ₍ₘ₎ is found by checking the existence of MVs or BVs in MV/BV storage corresponding to all five position of the current block as shown in FIG. 14. For instance, the center, top-left, top-right, bottom-left, and bottom-right of the current block 1400 are checked for MVs or BVs.

When pre-derived merge candidates targeting CMVP candidates has two MVs, a MV_{k/m} is derived for each merge index, each list (i.e., L0 and L1), and each trace depth. Trace depth may refer to the number of vectors that are considered recursively. For instance, in FIG. 13, the trace depth may be “m” (e.g., BVₖ₍₀₎ with RefPicL0ₖ₍₀₎ is at first trace depth, MVL0ₖ₍₁₎ with RefPicL0ₖ₍₁₎ is at second trace depth, and so forth until MVL0ₖ₍ₘ₎ with RefPicL0ₖ₍ₘ₎ being at the m^{th} trace depth). Up to two MVs can be derived for each list and each trace depth, and the MV set is sequentially inserted into inter merge candidate list. The traceable reference pictures are only within the reference picture list.

CMVP candidates are inserted after HMVP candidates for the regular merge and TM merge. When deriving CMVP candidates, hpeIIfIdx, bcwIdx, licFlag, and mhpFlag are not inherited. CMVP candidates are not derived when the TMVP is disabled.

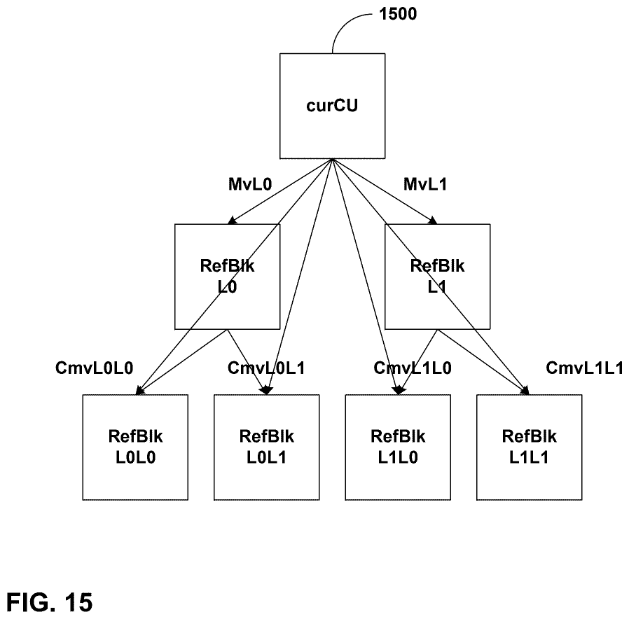

As illustrated in FIG. 15, for current block 1500, if the source motion is bi-prediction, two reference blocks RefBlkL0 and RefBlkL1 are found and at most 4 chained motion vectors could be traced if the both reference blocks are also bi-prediction blocks. That is, current block 1500 is inter-predicted using a first motion vector (MvL0) that points to a first reference block (RefBlk L0) in a first reference picture in reference picture list 0 (L0), and a second motion vector (MvL1) that points to a second reference block (RefBlk L1) in a second reference picture in reference picture list 1 (L1). If RefBlk L0 is inter-predicted with two motion vectors and two reference blocks (e.g., RefBlk L0L0 and RefBlk L0L1), then the are two CMPVs (e.g., CmvL0L0 and CmvL0L1). If RefBlk L1 is inter-predicted with two motion vectors and two reference blocks (e.g., RefBlk L1L0 and RefBlk L1L1), then the are two CMPVs (e.g., CmvL1L0 and CmvL1L1). This leads to a total of four CMPVs: CmvL0L0, CmvL0L1, CmvL1L0, and CmvL1L1.

In accordance with the techniques of this disclosure, to improve the coding efficiency of chained motion vector prediction, various techniques to derive the chained motion vector prediction in different merge modes are described in this disclosure. The example techniques are described with respect to motion vector prediction with temporal scaling, interaction of scaled motion vector and chained motion vector, and template matching based chained motion vector reordering.

For motion vector prediction with temporal scaling, an MVP candidate has at least one motion vector which is pointing to a reference picture A can be scaled to another reference picture, denote as ScaledRefPic. The techniques of scaling is to consider the distance between reference picture A to current picture and distance between reference picture P to the current picture. The techniques of scaling can be performed as described above and provided in illustration with respect to FIG. 7B. In one example, the MVP candidate has a scaling motion vector C (MvC), where the MvC is derived in one or several of the following steps, firstly derive a motion vector D (MvD) by using CMVP method to a motion vector E (MvE), and secondly MvC is derived by scaling MvD to a reference picture B, denote as CmvpScaledRefPic. In one example, MvE is derived as a spatial Mv, e.g. adjacent spatial Mv, non-adjacent spatial Mv. In one example, MvE is derived as a temporal Mv (TMVP).

For example, video encoder 200 and video decoder 300 may determine a source vector (e.g., MvE above). Video encoder 200 and video decoder 300 may generate an initial CMVP candidate (e.g., MvD above) based on the source vector (e.g., MvE). For example, MvE may MVL0ₖ₍₀₎ of FIG. 13, and MvD may be MVL0_{k/m} of FIG. 13. Video encoder 200 and video decoder 300 may scale the initial CMVP candidate (e.g., MvD) based on the current picture and a reference picture (e.g., CmvpScaledRefPic) to generate a CMVP candidate (e.g., MvC above) of the one or more CMVP candidates.

For example, video encoder 200 and video decoder 300 may determine a first picture order count (POC) value for the current picture, determine a second POC value for the reference picture (e.g., reference picture B), and determine a third POC value for a picture pointed to by the initial CMVP candidate. The respective POC values may be indicative of the display order of the respective pictures. Video encoder 200 and video decoder 300 may determine a first distance based on the first POC value and the third POC value (e.g., difference between first POC value and the third POC value), and determine a second distance based on the second POC value and the third POC value.

Video encoder 200 and video decoder 300 may scale the initial CMVP candidate based on the first distance and the second distance. For instance, video encoder 200 and video decoder 300 may determine a ratio of the first distance to the second distance, and multiply the initial CMVP candidate with the ratio to generate the CMVP candidate.

There may be various ways to determine the reference picture (CmvpScaledRefPic). For example, the reference picture (CmvpScaledRefPic) may be predefined or may be signaled.

In one example, the CmvpScaledRefPic is predetermined, e.g. the first reference picture in reference picture list X, wherein, X is 0 or 1. For instance, if MvE (e.g., source vector) pointed to a reference picture in list 0, then CmvpScaledRefPic may be the first reference picture in list 0. If MvE (e.g., source vector) pointed to a reference picture in list 1, then CmvpScaledRefPic may be the first reference picture in list 1.

In one example, a CMVP candidate is bi-prediction candidate, and the first MV is derived from the temporal trace and the first MV is on a reference picture A in reference list X, wherein X is 0 or 1. The second MV is derived from the temporal trace and the second MV is on a reference picture B in reference list (1-X).

In one case, a CmvpScaledRefPic is determined as a reference picture C in reference list (1-X), e.g. reference picture C is the first reference picture in reference list (1-X). The CMVP candidate has a first MV on reference picture A and a second MV on CmvpScaledRefPic, wherein the second MV is temporal scaled from picture B to CmvpScaledRefPic.

In one case, a CmvpScaledRefPic is determined as a reference picture C in reference list (1-X), e.g. reference picture C is the first reference picture in reference list (1-X). The CMVP candidate has a first MV on CmvpScaledRefPic, wherein the first MV is temporal scaled from picture A to CmvpScaledRefPic and a second MV on reference picture B.

In another case, a CmvpScaledRefPic is determined as a reference picture C in reference list (1-X) and minimum POC distance to reference picture A. The CMVP candidate has a first MV on reference picture A and a second MV on CmvpScaledRefPic, wherein the second MV is temporal scaled from picture B to CmvpScaledRefPic.

In another case, a CmvpScaledRefPic is determined as a reference picture C in reference list (1-X) and minimum POC distance to reference picture B. The CMVP candidate has a first MV on CmvpScaledRefPic, wherein the first MV is temporal scaled from picture A to CmvpScaledRefPic and a second MV on reference picture B.

In the above example techniques, for encoding or decoding a current block of a current picture, video encoder 200 and video decoder 300 may determine a source vector (e.g., MvE). The source vector may be a motion vector of an adjacent block, to the current block, in the current picture, a motion vector of a non-adjacent block, to the current block, in the current picture, or a motion vector of a block in another picture.

Video encoder 200 and video decoder 300 may input the source vector in a CMVP process (e.g., based on a defined trace depth or until an intra-predicted picture is found) to generate an initial CMVP candidate (e.g., MvD). Video encoder 200 and video decoder 300 may then scale the initial CMVP candidate (e.g., MvD) based on the current picture and a reference picture (e.g., CmvpScaledRefPic) to generate a CMVP candidate (e.g., MvC) of one or more CMVP candidates.

Accordingly, in the above techniques, video encoder 200 and video decoder 300 may determine a source vector, generate an initial CMVP candidate based on the source vector, and scale the CMVP candidate. However, the example techniques are not so limited, and the scaling may be in a different order. In some examples, video encoder 200 and video decoder 300 may first scale the source vector to generate a scaled source vector, and the input the scaled source vector in the CMVP process to generate a CMVP candidate. The following describes examples where the source vector is scaled first, and then the scaled source vector is used to determine a CMVP candidate.

For interaction of scaled motion vector and chained motion vector, a MVP candidate has a reference picture A in reference list X, when reference picture A is not a predetermined reference picture P in reference list X, the MV is scaled to reference picture P, e.g., reference picture P is the first reference picture in reference list X, by considering the distance between reference picture A to current picture and distance between reference picture P to the current picture. In some examples, the MVP is derived as TMVP. In some examples, the MVP is derived as spatial MVP. The scaled MV is further used as a source candidate to derive CMVP.

As an example, video encoder 200 and video decoder 300 may determine a source vector for a current block in a current picture is a TMVP (e.g., a motion vector of a block in another picture). This other picture may be referred to as reference picture A. That is, reference picture A includes the block whose motion vector is used as the source vector. In this example, assume that the source vector points to reference picture N. Accordingly, in this example, there are three pictures of interest: current picture, reference picture A (e.g., the picture that includes block having the source vector), and reference picture N (e.g., the picture that the source vector points to).

Assume that reference picture N is list 0 for reference picture A. Video encoder 200 and video decoder 300 may determine whether reference picture N is a first picture in list 0 for the current picture. If reference picture N is not the first picture in list 0, video encoder 200 and video decoder 300 may scale the source vector based on a distance (e.g., POC values) between the current picture and reference picture A, and the distance between the current picture and the first picture in list 0 for the current picture.

In some examples, TMVP candidates is derived which the reference index of these TMVP candidates is always equal to N, which is denoted as RefNTMVP. This RefNTMVP is derived and stored to an independent merge list which is denoted as RefNTMVP list. For one example, N can be 0 so that the candidates in the Ref0TMVP list are always pointing to the first reference picture in the reference picture list. After RefNTMVP derivation, CMVP is derived from the RefNTMVP candidates in the list and may be inserted to the RefNTMVP list.

For example, for a current block in a current picture, video encoder 200 and video decoder 300 may determine a first motion vector for a first block in a first picture that points to a first reference picture in list 0 for the first picture. This first motion vector is a first Ref0TMVP. Video encoder 200 and video decoder 300 may determine a second motion vector for a second block in a first picture or a second picture that points to a first reference picture in list 0 for the first picture or the second picture. This second motion vector is a second Ref0TMVP. Video encoder 200 and video decoder 300 may repeat these steps to determine X number of Ref0TMVPs (e.g., X number of motion vectors from blocks in a picture other than the current picture that point to the first reference picture in a reference picture list).

The X number of Ref0TMVPs may each be possible motion vector candidates for the current block. In addition, video encoder 200 and video decoder 300 may enter each of the X number of Ref0TMVPs in the CMVP process to determine X number of CMVPs. That is, each of the X number of Ref0TMVPs, possibly after scaling, may be source vectors of the CMVP process, and the output may be X number of CMVPs. The X number of CMVPs may also be candidates

As described above, video encoder 200 and video decoder 300 may determine a motion vector for the current block. In the above example, some candidates for the motion vector for the current block may be each of the X number of Ref0TMVPs and each of the X number of CMVPs, where each of the X number of CMVPs is determined from a corresponding on of the X number of Ref0TMVPs through a process similar to that described above with respect to FIGS. 13-15.

Stated another way, video encoder 200 and video decoder 300 may determine a first CMVP candidate from a first TMVP (e.g., the source vector to determine a first CMVP is a first TMVP and is a motion vector of a block in a different picture than the current picture). Video encoder 200 and video decoder 300 may determine a second TMVP that points to a reference picture identified in a same index in a reference picture list as a reference picture pointed to by the first TMVP. In this example, video encoder 200 and video decoder 300 may determine a second CMVP candidate of the one or more CMVP candidates based on the second TMVP.

Video encoder 200 and video decoder 300 may determine a first set of template matching costs for the first TMVP and the second TMVP, and determine a second set of template matching costs for each of the one or more CMVP candidates. Video encoder 200 and video decoder 300 may construct a TMVP list (e.g., RefNTMVP list) that includes the first TMVP and the second TMVP and is ordered based on the first set of template matching costs. Video encoder 200 and video decoder 300 may construct a list of CMVP candidates that includes the first CMVP candidate and the second CMVP candidate and is ordered based on the second set of template matching costs. Video encoder 200 and video decoder may construct a list of candidate motion vector predictors based on the TMVP list and the list of CMVP candidates, and encode or decode the current block based on the list of candidate motion vector predictors.

In one example, a MVP candidate has at least one motion vector A (MvA), where the MvA is derived in one or several of the following steps, firstly derive a motion vector B (MvB) as a spatial or temporal Mvp, and secondly, derive a motion vector C (MvC) by scaling MvB to a reference picture B, e.g. first reference picture in reference list X, X is equal to 0 or 1, and thirdly derive MvA by using CMVP method to MvC.

For example, video encoder 200 and video decoder 300 may determine a source vector (e.g., MvB above). Video encoder 200 and video decoder 300 may scale the source vector (e.g., MvB) based on the current picture and a reference picture (e.g., reference picture B) to generate a scaled source vector (e.g., MvC above). Video encoder 200 and video decoder 300 may generate a CMVP candidate (e.g., MvA above) of the one or more CMVP candidates based on the scaled source vector. In some examples, when deriving CMVP, if the source candidate motion is not pointing to the first reference picture in the reference list, the source candidate will be scaled to the first reference picture to derive CMVP.

In some examples, after RefNTMVP candidates and its CMVP candidates are derived, template cost is calculated for each candidate in the RefNTMVP list, the candidates in the list are reordered by the template cost. In some examples, when RefNTMVP list is reordering, only the first M candidates with the minimum template cost is retained.

For example, there may be two sets of motion vector predictor candidates. The first set includes X number of RefNTMVPs, and the second set includes X number of CMVPs, where each of the X number of CMVPs is derived based on one of the X number of RefNTMVPs. In some examples, video encoder 200 and video decoder 300 may reorder the RefNTMVPs based on template cost of each of the X number of RefNTMVPs. In some examples, video encoder 200 and video decoder 300 may reorder the X number of CMVPs based on template cost. After the reordering, video encoder 200 and video decoder 300 may generate a larger list of motion vector predictor candidates that includes the RefNTMVPs and the CMVPs, and then reorder the RefNTMVPs and the CMVPs.

In some examples, when RefNTMVP list is reordered, if the difference of the template cost of two candidates is smaller than a threshold (i.e. abs(TMcostcandA−TMcostcandB)<K), one candidate will be removed from the list. In some examples, the candidate with larger template cost will be removed from the list.

In some examples, after TMVP, RefNTMVP candidates and RefNTMVP CMVP candidates are derived, template cost is calculated for each candidate in the RefNTMVP list and TMVP list, the candidates in two lists are combined and reordered by the template cost. The RefNTMVP CMVP candidates refer to the X number of CMVP candidates that are derived using CMVP process with the RefNTMVP candidates being inputs (e.g., being the source vectors). In some examples, when the two lists are reordered, only the first M candidates with the minimum template cost is retained.

In some examples, when two lists are reordered, if the difference of the template cost of two candidates is smaller than a threshold (i.e. abs(TMcostcandA−TMcostcandB)<K), one candidate will be removed from the list.

For template matching based chained motion vector reordering, various techniques may be used to sort (e.g., order or reorder) the CMVP candidates based on template matching cost. In some cases, the CMVP candidates list is sorted based on template matching cost, the first N CMVP with smaller TM (template matching) cost are selected as the motion vector candidates for the current block. In some cases, the CMVP candidates is jointly sorted with a second MVP candidate list based on template matching cost, the first N candidates are selected as the motion vector candidates for the current block, where, the second MVP candidate list can be a candidate list constructed by using spatial MVP, TMVP, HVMP, etc.

In some examples, template cost is calculated for the source candidate and its CMVP candidate, if the difference of the template cost of two candidates is smaller than a threshold, CMVP candidate will be removed from the list.

In some examples, template cost is calculated for the source candidate and its CMVP candidate, if the template cost of its CMVP candidate is smaller than the source candidate, the source candidate will be replaced with its CMVP candidate.

In some examples, template cost is calculated for the source candidate and its CMVP candidate, if the difference of the template cost of two candidates is smaller than a threshold or the template cost of CMVP candidate is larger than the source candidate, CMVP candidate will be removed from the list.

In some examples, for a source candidate, CMVP can be derived until trace depth N, where N is larger than 1, denoted as CMVPdepth1 . . . CMVPdepthN, template cost is calculated for all CMVP candidates, the CMVP candidate with minimum cost will be inserted into the merge list.

In some examples, for a source candidate, CMVP can be derived until trace depth N, where N is larger than 1, denoted as CMVPdepth1 . . . CMVPdepthN, template cost is calculated for the source candidate and its all CMVP candidates, the candidate with minimum cost will be inserted into the merge list.

In some examples, when deriving CMVP, if the source candidate motion is not pointing to the first reference picture in the reference list, the source candidate will be scaled to the first reference picture to derive CMVP.

In some examples, when deriving CMVPdepth1 . . . CMVPdepth(N−1), it will be scaled to the first reference picture for the further derivation of CMVP.

In accordance with examples described in this disclosure, video encoder 200 and video decoder 300 may determine a list of candidate motion vector predictors. For instance, video encoder 200 and video decoder 300 may generate a candidate list of vectors. The candidate list of vectors may include merge candidates (e.g., motion vectors of spatial or temporal neighboring blocks), HMVP candidates, and CMVP candidates.

There may be various ways in which to generate the CMVP candidates. As one example, video encoder 200 and video decoder 300 may determine a source vector, and determine an initial CMVP candidate based on the source vector. Video encoder 200 and video decoder 300 may then scale the initial CMVP to generate a CMVP candidate. Video encoder 200 and video decoder 300 may repeat such operations with another source vector to generate a second CMVP candidate, and so forth to generate one or more CMVP candidates. As another example, rather than or in addition to scaling the initial CMVP candidate, video encoder 200 and video decoder 300 may scale the source vector, and generate a CMVP candidate based on the scaled source vector. Video encoder 200 and video decoder 300 may repeat such operations with another source vector to generate a second CMVP candidate, and so forth to generate one or more CMVP candidates.

In some examples, the various above techniques may be used together to determine the list of candidate motion vector predictors. For instance, video encoder 200 and video decoder 300 may determine a first set of CMVP candidates where different source vectors are used to determine different initial CMVP candidates, and these different initial CMVP candidates are scaled to generate the first set of CMVP candidates. Video encoder 200 and video decoder 300 may also determine a second set of CMVP candidates where different source vectors are scaled to determine different CMVP candidates to generate the second set of CMVP candidates. Video encoder 200 and video decoder 300 may include one or more of the first set of CMVP candidates and the second set of CMVP candidates in the list of candidate motion vector predictors.

In the examples, the source vector may be a motion vector of an adjacent block, to the current block, in the current picture, a motion vector of a non-adjacent block, to the current block, in the current picture, or a motion vector of a block in another picture. In some examples, the scaling of the initial CMVP candidate or the source vector may be based on a first reference picture in a reference picture list (e.g., list 0 or list 1). For instance, the scaling may be performed based on the POC (picture order count) values.

In examples where the source vector is initially scaled, there may be a plurality of source vectors that are each TMVPs (e.g., motion vector of a block in a different picture than the current picture). For example, a first source vector may be a first motion vector for a first block in a different picture than the current picture, a second source vector may be a second motion vector for a second block in the different picture, or yet another different picture than the current picture, and so forth. In some examples, each of these TMVPs (e.g., first source vector, second source vector, and so on) may point to a block in a reference picture that is N^{th} reference picture in a reference picture list. For instance, assume N is 0, in this example, the first source vector may be a TMVP that points to a reference picture identified at index 0 in a reference picture list (e.g., list 0 or list 1), the second source vector may be a TMVP that points to a reference picture identified at index 0 in a reference picture list (e.g., list 0 or list 1), and so forth. This list of TMVPs may be referred to RefNTMVP list, or Ref0TMVP in the example where N equals 0. Another name for RefNTMVP list may be simply TMVP list.

Video encoder 200 and video decoder 300 may determine a CMVP corresponding to each of TMVPs in the TMVP list. For instance, video encoder 200 and video decoder 300 may scale the first TMVP in the TMVP list (e.g., RefNTMVP list) to generate a scaled first TMVP, and input the scaled first TMVP through the CMVP process to determine a first CMVP candidate. Video encoder 200 and video decoder 300 may scale the second TMVP in the TMVP list (e.g., RefNTMVP list) to generate a scaled second TMVP, and input the scaled second TMVP through the CMVP process to determine a second CMVP candidate, and so forth.

In some examples, video encoder 200 and video decoder 300 may include all of the CMVP candidates in the list of candidate motion vector predictors. That is, the list of candidate motion vector predictors may include CMVP candidates generated from determining an initial CMVP candidate from a source vector, and then scaling, and CMVP candidates generated from scaling a source vector, and then determining the CMVP candidate from the scaled source vector. Video encoder 200 and video decoder 300 may also include TMVPs from the TMVP list in the list of motion vector predictors.

Video encoder 200 and video decoder 300 may perform template matching techniques to determine a cost associated with each of the CMVP candidates. Video encoder 200 and video decoder 300 may include the CMVP candidates and/or TMVPs in the list of motion vector predictors ordered from lowest cost (e.g., lower index value in list of motion vector predictors) to highest cost (e.g., higher index value in list of motion vector predictors).

However, in some examples, video encoder 200 and video decoder 300 may perform culling or initial reordering. For example, video encoder 200 and video decoder 300 may perform reordering of the TMVP list (e.g., RefNTMVP list) based on the template matching costs, and perform reordering of the CMVP candidates (e.g., CMVP candidates generated from first scaling the source vector). After such reordering, video encoder 200 and video decoder 300 may maintain the first X number of candidates in the TMVP list and/or CMVP candidates, and cull the rest. Video encoder 200 and video decode 300 may include the remaining candidates in the TMVP list and the CMVP candidates in the list of candidate motion vector predictors, and then perform another reordering operation to reorder all of the motion vector predictors in the list based on the template matching costs.

There may be various other ways in which the list of candidate motion vector predictors can be constructed using CMVP candidates generated from the example techniques described in this disclosure. The above example techniques for constructing the list of candidate motion vector predictors should not be considered limiting.

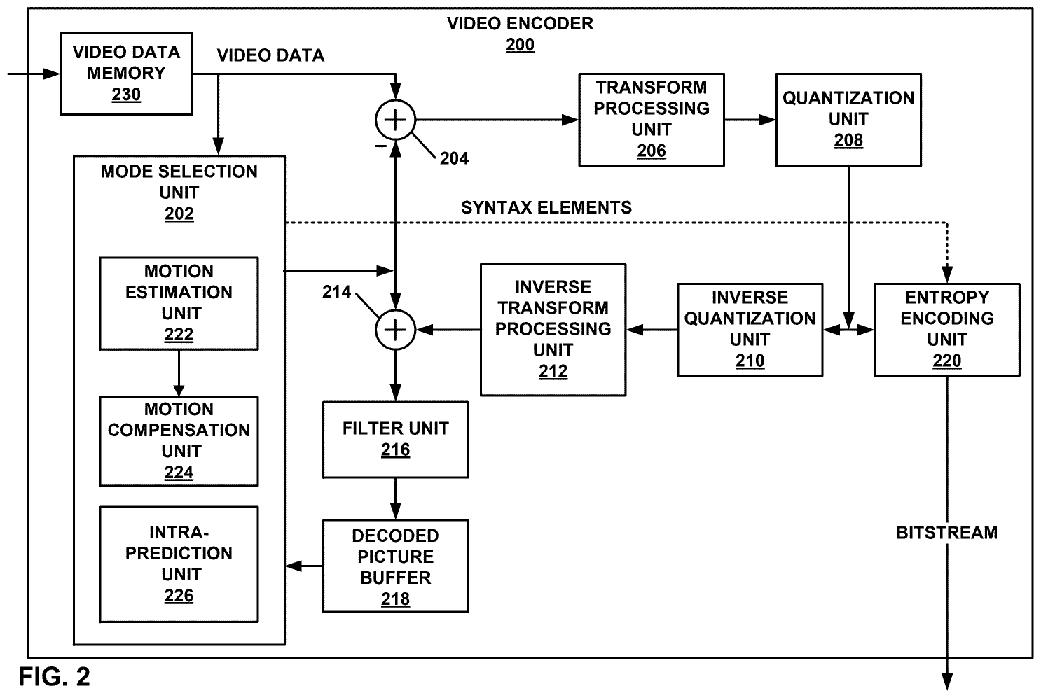

FIG. 2 is a block diagram illustrating an example video encoder 200 that may perform the techniques of this disclosure. FIG. 2 is provided for purposes of explanation and should not be considered limiting of the techniques as broadly exemplified and described in this disclosure. For purposes of explanation, this disclosure describes video encoder 200 according to the techniques of VVC and HEVC. However, the techniques of this disclosure may be performed by video encoding devices that are configured to other video coding standards and video coding formats, such as AV1 and successors to the AV1 video coding format.

In the example of FIG. 2, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 is an example of a memory system that may store video data to be encoded by the components of video encoder 200. Video encoder 200 may receive the video data stored in video data memory 230 from, for example, video source 104 (FIG. 1). DPB 218 is an example of a memory system that may act as a reference picture memory that stores reference video data for use in prediction of subsequent video data by video encoder 200. Video data memory 230 and DPB 218 may each be formed by any of a variety of one or more memory devices or memory units, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 2 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra-prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to determine one or more chained motion vector prediction (CMVP) candidates for a current block of a current picture. To determine the one or more CMVP candidates, video encoder 200 may be configured to determine a source vector, generate an initial CMVP candidate based on the source vector, and scale the initial CMVP candidate based on the current picture and a reference picture to generate a CMVP candidate of the one or more CMVP candidates.

In some examples, video encoder 200 may be configured to determine one or more chained motion vector prediction (CMVP) candidates for a current block of a current picture. To determine the one or more CMVP candidates, video encoder 200 may be configured to determine a source vector, scale the source vector based on the current picture and a reference picture to generate a scaled source vector, and generate a CMVP candidate of the one or more CMVP candidates based on the scaled source vector.

Video encoder 200 may encode the current block based on the one or more CMVP candidates. Video encoder 200 may determine a prediction signal based on one of the one or more CMVP candidates, determine information indicative of a residual between the prediction signal and the current block, and signal the information indicative of the residual.

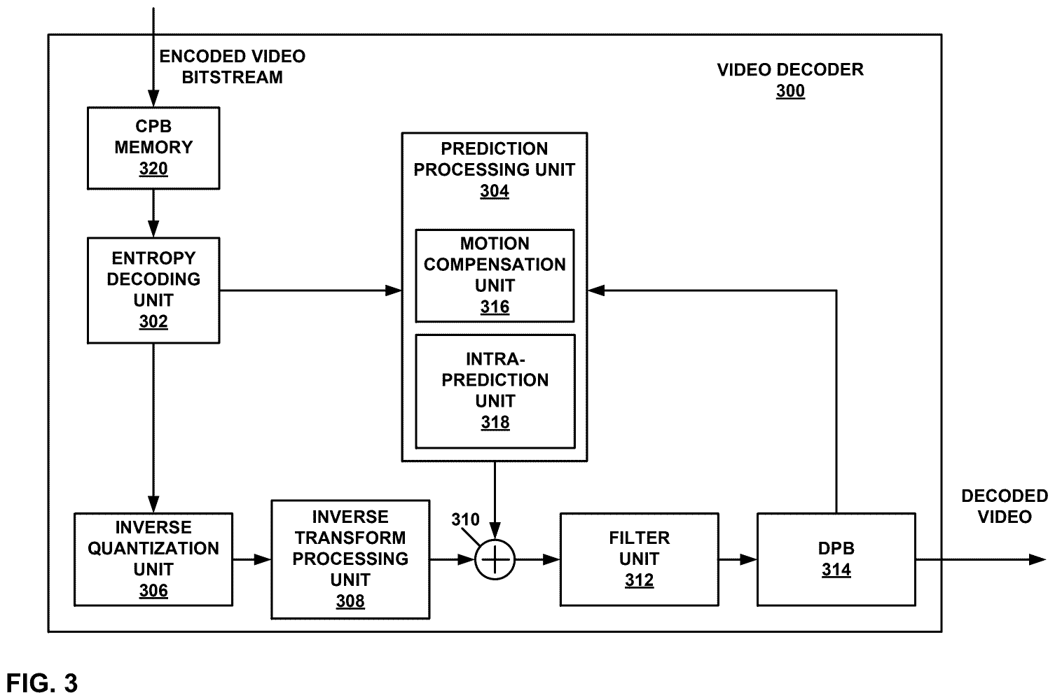

FIG. 3 is a block diagram illustrating an example video decoder 300 that may perform the techniques of this disclosure. FIG. 3 is provided for purposes of explanation and is not limiting on the techniques as broadly exemplified and described in this disclosure. For purposes of explanation, this disclosure describes video decoder 300 according to the techniques of VVC and HEVC. However, the techniques of this disclosure may be performed by video coding devices that are configured to other video coding standards.

In the example of FIG. 3, video decoder 300 includes coded picture buffer (CPB) memory 320, entropy decoding unit 302, prediction processing unit 304, inverse quantization unit 306, inverse transform processing unit 308, reconstruction unit 310, filter unit 312, and DPB 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra-prediction unit 318 may be configured to decode coding blocks of video data (e.g., both luma and chroma coding blocks) using directional intra prediction, non-directional intra prediction, recursive filter intra prediction, CFL, IBC, and/or color palette mode, as described above.

CPB memory 320 is an example of a memory system that may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 is an example of a memory system that generally stores decoded pictures, which video decoder 300 may output and/or use as reference video data when decoding subsequent data or pictures of the encoded video bitstream. CPB memory 320 and DPB 314 may each be formed by any of a variety of memory devices or memory units, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 3 are illustrated to assist with understanding the operations performed by video decoder 300. The units may be implemented as fixed-function circuits, programmable circuits, or a combination thereof. Similar to FIG. 2, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 2).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 2). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to determine one or more chained motion vector prediction (CMVP) candidates for a current block of a current picture. To determine the one or more CMVP candidates, video decoder 300 may be configured to determine a source vector, generate an initial CMVP candidate based on the source vector, and scale the initial CMVP candidate based on the current picture and a reference picture to generate a CMVP candidate of the one or more CMVP candidates.

In some examples, video decoder 300 may be configured to determine one or more chained motion vector prediction (CMVP) candidates for a current block of a current picture. To determine the one or more CMVP candidates, video decoder 300 may be configured to determine a source vector, scale the source vector based on the current picture and a reference picture to generate a scaled source vector, and generate a CMVP candidate of the one or more CMVP candidates based on the scaled source vector.

Video decoder may decode the current block based on the one or more CMVP candidates. Video decoder 300 may determine a prediction signal based on one of the one or more CMVP candidates, receive information indicative of a residual between the prediction signal and the current block, and reconstruct the current block based on the residual and the prediction signal.

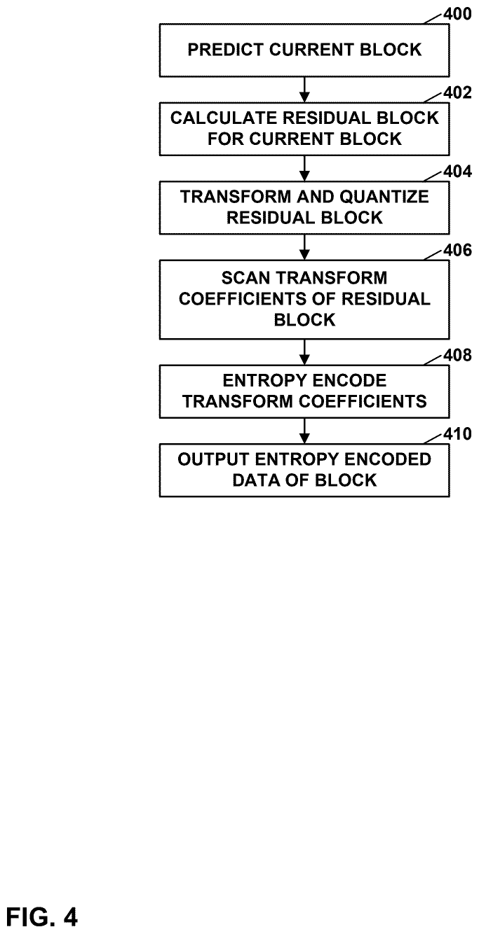

FIG. 4 is a flowchart illustrating an example method for encoding a current block in accordance with the techniques of this disclosure. The current block may be or include a current CU. Although described with respect to video encoder 200 (FIGS. 1 and 2), it should be understood that other devices may be configured to perform a method similar to that of FIG. 4.

In this example, video encoder 200 initially predicts the current block (400). For example, video encoder 200 may form a prediction block for the current block. Video encoder 200 may then calculate a residual block for the current block (402). To calculate the residual block, video encoder 200 may calculate a difference between the original, unencoded block and the prediction block for the current block. Video encoder 200 may then transform the residual block and quantize transform coefficients of the residual block (404). Next, video encoder 200 may scan the quantized transform coefficients of the residual block (406). During the scan, or following the scan, video encoder 200 may entropy encode the transform coefficients (408). For example, video encoder 200 may encode the transform coefficients using CAVLC or CABAC. Video encoder 200 may then output the entropy encoded data of the block (410).

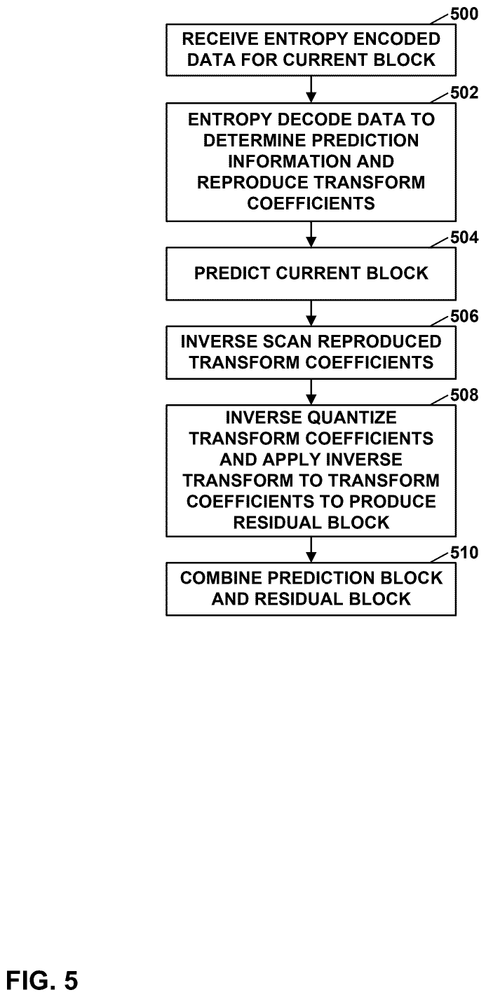

FIG. 5 is a flowchart illustrating an example method for decoding a current block of video data in accordance with the techniques of this disclosure. The current block may be or include a current CU. Although described with respect to video decoder 300 (FIGS. 1 and 3), it should be understood that other devices may be configured to perform a method similar to that of FIG. 5.

Video decoder 300 may receive entropy encoded data for the current block, such as entropy encoded prediction information and entropy encoded data for transform coefficients of a residual block corresponding to the current block (500). Video decoder 300 may entropy decode the entropy encoded data to determine prediction information for the current block and to reproduce transform coefficients of the residual block (502). Video decoder 300 may predict the current block (504), e.g., using an intra- or inter-prediction mode as indicated by the prediction information for the current block, to calculate a prediction block for the current block. Video decoder 300 may then inverse scan the reproduced transform coefficients (506), to create a block of quantized transform coefficients. Video decoder 300 may then inverse quantize the transform coefficients and apply an inverse transform to the transform coefficients to produce a residual block (508). Video decoder 300 may ultimately decode the current block by combining the prediction block and the residual block (510).

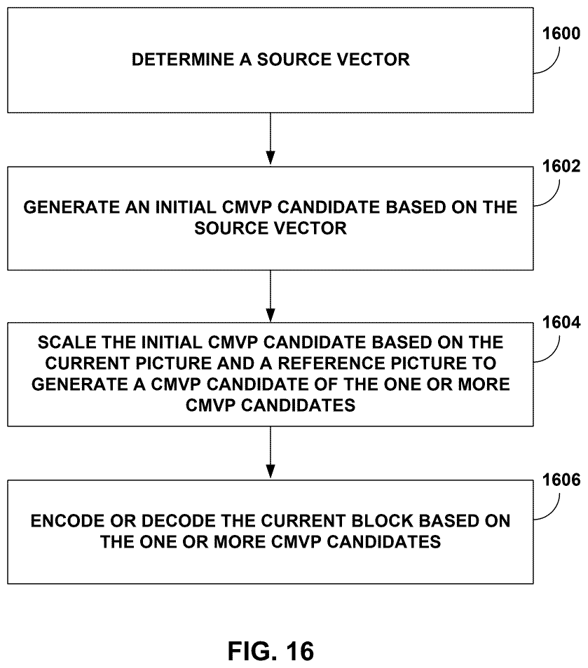

FIG. 16 is a flowchart illustrating an example method of encoding or decoding video data. The example of FIG. 16 is described with respect to processing circuitry, such as processing circuitry of video encoder 200 or video decoder 300. As an example, the processing circuitry may be coupled to one or more memories like memory 106, memory 120, video data memory 230, DPB 218, CPB memory 320, DPB 314, or other memory that stores video data. The processing circuitry may be configured to determine one or more chained motion vector prediction (CMVP) candidates for a current block of a current picture.

The processing circuitry may determine a source vector (1600). An example of the source vector includes one of a motion vector of an adjacent block, to the current block, in the current picture, a motion vector of a non-adjacent block, to the current block, in the current picture, or a motion vector of a block in another picture.

The processing circuitry may generate an initial CMVP candidate based on the source vector (1602). For instance, the source vector may be an input into the CMVP process, and the output may be the initial CMVP candidate. As an example, to generate the initial CMVP candidate based on the source vector, the processing circuitry may accumulate recursively traced motion vectors or block vectors for a trace depth starting from the source vector. Each of the traced motion vectors or block vectors is a motion vector or block vector for a block pointed to by a previous motion vector or block vector of the traced motion vectors or block vectors. For instance, as illustrated in FIG. 13, MVL0ₖ₍₀₎ may be the source vector, and MVL0_{k/m} may be the initial CMVP candidate. Also, as can be seen in FIG. 13, MVL0ₖ₍₁₎ is a motion vector or block vector for a block that is pointed to by a previous motion vector or block vector (e.g., MVL0ₖ₍₀₎) of the traced motion vectors or block vectors. In this example, the traced motion vectors include MVL0ₖ₍₀₎+BVₖ₍₀₎+MVL0ₖ₍₁₎+MVL0ₖ₍₂₎+ . . . +MVL0ₖ₍ₘ₎. In this example, the trace depth is two, and the recursive accumulation may be MVL0_{k/m}=MVL0ₖ₍₀₎+BVₖ₍₀₎+MVL0ₖ₍₁₎+MVL0ₖ₍₂₎+ . . . +MVL0ₖ₍ₘ₎.

The processing circuitry may scale the initial CMVP candidate based on the current picture and a reference picture to generate a CMVP candidate of the one or more CMVP candidates (1604). For example, the processing circuitry may determine a first picture order count (POC) value for the current picture, determine a second POC value for the reference picture, and determine a third POC value for a picture pointed to by the initial CMVP candidate. The respective POC values may be indicative of the display order of the respective pictures. The processing circuitry may determine a first distance based on the first POC value and the third POC value (e.g., difference between first POC value and the third POC value), and determine a second distance based on the second POC value and the third POC value.

The processing circuitry may scale the initial CMVP candidate based on the first distance and the second distance. For instance, the processing circuitry may determine a ratio of the first distance to the second distance, and multiply the initial CMVP candidate with the ratio to generate the CMVP candidate.

The processing circuitry may encode or decode the current block based on the one or more CMVP candidates (1606). For instance, the processing circuitry may repeat the above example techniques to generate another CMPV candidate. As an example, the processing circuitry may determine a second source vector, generate a second initial CMVP candidate based on the source vector, and scale the second CMVP candidate based on the current picture and a second reference picture to generate a second CMVP candidate of the one or more CMVP candidates. In this way, the processing circuitry may generate the one or more CMVP candidates.

The processing circuitry may construct a list of candidate motion vector predictors that includes the one or more CMVP candidates. In this example, to encode or decode the current block, the processing circuitry may encode or decode the current block based on the list of candidate motion vector predictors. To construct the list of candidate motion vector predictors, the processing circuitry may order the list of candidate motion vector predictors based on a template matching cost of the one or more CMVP candidates (e.g., least cost to most cost).

To decode the current block, the processing circuitry of video decoder 300 may parse an index into the list of candidate motion vector predictors to identify a motion vector predictor, and determine a motion vector for the current block based on the motion vector predictor. The processing circuitry of video decoder 300 may determine a prediction signal based on the motion vector (e.g., based on the block pointed to by the motion vector). The processing circuitry of video decoder 300 may receive information indicative of a residual between the prediction signal and the current block, and reconstruct the current block based on the residual and the prediction signal.

To encode the current block, the processing circuitry of video encoder 200 may be configured to signal an index into the list of candidate motion vector predictors to identify a motion vector predictor used for determining a motion vector for the current block. The processing circuitry of video encoder 200 may determine a prediction signal based on the motion vector (e.g., based on the block pointed to by the motion vector), and signal information indicative of a residual between the prediction block and the current block.

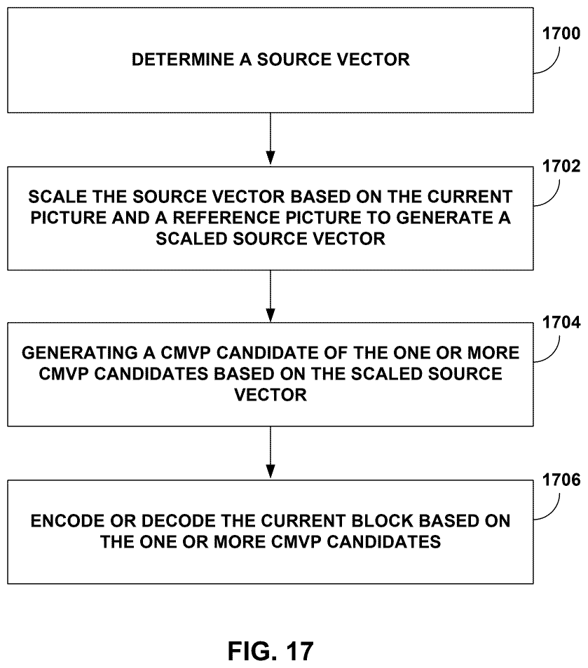

FIG. 17 is a flowchart illustrating another example method of encoding or decoding video data. The example of FIG. 17 is described with respect to processing circuitry, such as processing circuitry of video encoder 200 or video decoder 300. As an example, the processing circuitry may be coupled to one or more memories like memory 106, memory 120, video data memory 230, DPB 218, CPB memory 320, DPB 314, or other memory that stores video data. The processing circuitry may be configured to determine one or more chained motion vector prediction (CMVP) candidates for a current block of a current picture.

The processing circuitry may determine a source vector (1700). An example of the source vector includes one of a motion vector of an adjacent block, to the current block, in the current picture, a motion vector of a non-adjacent block, to the current block, in the current picture, or a motion vector of a block in another picture.

The processing circuitry may scale the source vector based on the current picture and a reference picture to generate a scaled source vector (1702). For example, the processing circuitry may determine a first picture order count (POC) value for the current picture, determine a second POC value for the reference picture, and determine a third POC value for a picture pointed to by the source vector. The respective POC values may be indicative of the display order of the respective pictures. The processing circuitry may determine a first distance based on the first POC value and the third POC value (e.g., difference between first POC value and the third POC value), and determine a second distance based on the second POC value and the third POC value.

The processing circuitry may scale the source vector based on the first distance and the second distance. For instance, the processing circuitry may determine a ratio of the first distance to the second distance, and multiply the source vector with the ratio to generate the scaled source vector.

The processing circuitry may generate a CMVP candidate based on the scaled source vector (1704). For instance, the scaled source vector may be an input into the CMVP process, and the output may be the CMVP candidate. As an example, to generate the CMVP candidate based on the scaled source vector, the processing circuitry may accumulate recursively traced motion vectors or block vectors for a trace depth starting from the scaled source vector. Each of the traced motion vectors or block vectors is a motion vector or block vector for a block pointed to by a previous motion vector or block vector of the traced motion vectors or block vectors. For instance, as illustrated in FIG. 13, MVL0ₖ₍₀₎ may be the scaled source vector, and MVL0_{k/m} may be the CMVP candidate. Also, as can be seen in FIG. 13, MVL0ₖ₍₁₎ is a motion vector or block vector for a block that is pointed to by a previous motion vector or block vector (e.g., MVL0ₖ₍₀₎) of the traced motion vectors or block vectors. In this example, the traced motion vectors include MVL0ₖ₍₀₎+BVₖ₍₀₎+MVL0ₖ₍₁₎+MVL0ₖ₍₂₎+ . . . +MVL0ₖ₍ₘ₎. In this example, the trace depth is two, and the recursive accumulation may be MVL0_{k/m}=MVL0ₖ₍₀₎+BVₖ₍₀₎+MVL0ₖ₍₁₎+MVL0ₖ₍₂₎+ . . . +MVL0ₖ₍ₘ₎.

The processing circuitry may encode or decode the current block based on the one or more CMVP candidates (1706). The processing circuitry may construct a list of candidate motion vector predictors that includes the one or more CMVP candidates, and encode or decode the current block based on the list of candidate motion vector predictors. There may be various ways in which to construct the list of candidate motion vector predictors.

As one example, the CMVP candidate is a first CMVP candidate, the source vector is a first temporal motion vector predictor (TMVP) and is a motion vector of a block in a different picture than the current picture. The processing circuitry may determine a second TMVP that points to a reference picture identified in a same index in a reference picture list as a reference picture pointed to by the first TMVP, and determine a second CMVP candidate of the one or more CMVP candidates based on the second TMVP.

In this example, the processing circuitry may determine a first set of template matching costs for the first TMVP and the second TMVP, determine a second set of template matching costs for each of the one or more CMVP candidates, construct a TMVP list that includes the first TMVP and the second TMVP and is ordered based on the first set of template matching costs, construct a list of CMVP candidates that includes the first CMVP candidate and the second CMVP candidate and is ordered based on the second set of template matching costs, and construct a list of candidate motion vector predictors based on the TMVP list and the list of CMVP candidates. The processing circuitry may encode or decode the current block based on the list of candidate motion vector predictors.

As another example, the source vector is a first source vector, the scaled source vector is a first scaled source vector, the CMVP candidate is a first CMPV candidate, and the reference picture is a first reference picture. The processing circuitry may determine a second source vector, scale the source vector based on the current picture and a second reference picture to generate a second scaled source vector, and generate a second CMVP candidate of the one or more CMVP candidates based on the second scaled source vector. The processing circuitry may generate a list of candidate motion vector predictors using the first CMVP candidate and the second CMVP candidate.

To decode the current block, the processing circuitry of video decoder 300 may parse an index into the list of candidate motion vector predictors to identify a motion vector predictor, and determine a motion vector for the current block based on the motion vector predictor. The processing circuitry of video decoder 300 may determine a prediction signal based on the motion vector (e.g., based on the block pointed to by the motion vector). The processing circuitry of video decoder 300 may receive information indicative of a residual between the prediction signal and the current block, and reconstruct the current block based on the residual and the prediction signal.

To encode the current block, the processing circuitry of video encoder 200 may be configured to signal an index into the list of candidate motion vector predictors to identify a motion vector predictor used for determining a motion vector for the current block. The processing circuitry of video encoder 200 may determine a prediction signal based on the motion vector (e.g., based on the block pointed to by the motion vector), and signal information indicative of a residual between the prediction block and the current block.

The following numbered clauses illustrate one or more aspects of the devices and techniques described in this disclosure.

Clause 1A. A method of encoding or decoding video data, the method comprising: determining one or more chained motion vector prediction (CMVP) candidates for a current block of a current picture, wherein determining the one or more CMVP candidates comprises: determining a source vector; generating an initial CMVP candidate based on the source vector; and scaling the initial CMVP candidate based on the current picture and a reference picture to generate a CMVP candidate of the one or more CMVP candidates; and encoding or decoding the current block based on the one or more CMVP candidates.

Clause 2A. The method of clause 1A, wherein the source vector comprises one of a motion vector of an adjacent block, to the current block, in the current picture, a motion vector of a non-adjacent block, to the current block, in the current picture, or a motion vector of a block in another picture.

Clause 3A. The method of any of clauses 1A and 2A, wherein the reference picture is a predetermined picture in one of a first or second reference picture list.

Clause 4A. The method of any of clauses 1A-3A, wherein the source vector is a first source vector, the initial CMVP candidate is a first initial CMVP candidate, the CMVP candidate is a first CMPV candidate, and the reference picture is a first reference picture, the method further comprising: determining a second source vector; generating a second initial CMVP candidate based on the source vector; and scaling the second CMVP candidate based on the current picture and a second reference picture to generate a second CMVP candidate of the one or more CMVP candidates.

Clause 5A. The method of clause 4A, further comprising: constructing a CMVP candidate list that includes the first CMVP candidate and the second CMVP candidate, wherein encoding or decoding the current block comprises encoding or decoding the current block based on the CMVP candidate list.

Clause 6A. The method of clause 5A, wherein constructing the CMVP candidate list comprises ordering the CMVP candidate list based on a template matching cost of the first CMVP candidate and a template matching cost of the second CMVP candidate.

Clause 7A. A method of encoding or decoding video data, the method comprising: determining one or more chained motion vector prediction (CMVP) candidates for a current block of a current picture, wherein determining the one or more CMVP candidates comprises: determining a source vector; scaling the source vector based on the current picture and a reference picture to generate a scaled source vector; and generating a CMVP candidate of the one or more CMVP candidates based on the scaled source vector; and encoding or decoding the current block based on the one or more CMVP candidates.

Clause 8A. The method of clause 7A, wherein the source vector comprises one of a motion vector of an adjacent block, to the current block, in the current picture, a motion vector of a non-adjacent block, to the current block, in the current picture, or a motion vector of a block in another picture.

Clause 9A. The method of any of clauses 7A and 8A, wherein the reference picture is a predetermined picture in one of a first or second reference picture list.

Clause 10A. The method of any of clauses 7A-9A, wherein the source vector is a first source vector, the scaled source vector is a first scaled source vector, the CMVP candidate is a first CMPV candidate, and the reference picture is a first reference picture, the method further comprising: determining a second source vector; scaling the source vector based on the current picture and a second reference picture to generate a second scaled source vector; and generating a second CMVP candidate of the one or more CMVP candidates based on the second scaled source vector;

Clause 11A. The method of clause 10A, further comprising: constructing a CMVP candidate list that includes the first CMVP candidate and the second CMVP candidate, wherein encoding or decoding the current block comprises encoding or decoding the current block based on the CMVP candidate list.

Clause 12A. The method of clause 11A, wherein constructing the CMVP candidate list comprises ordering the CMVP candidate list based on a template matching cost of the first CMVP candidate and a template matching cost of the second CMVP candidate.

Clause 13A. The method of any of clauses 1A-12A, wherein encoding or decoding the current block comprises decoding the current block, and wherein decoding the current block comprises: determining a prediction signal based on one of the one or more CMVP candidates; receiving information indicative of a residual between the prediction signal and the current block; and reconstructing the current block based on the residual and the prediction signal.

Clause 14A. The method of any of clauses 1A-12A, wherein encoding or decoding the current block comprises encoding the current block, and wherein encoding the current block comprises: determining a prediction signal based on one of the one or more CMVP candidates; determining information indicative of a residual between the prediction signal and the current block; and signaling the information indicative of the residual.

Clause 15A. A device for encoding or decoding video data, the device comprising: one or more memories configured to store the video data; and processing circuitry configured to perform the method of any one or combination of clauses 1-14.

Clause 16A. The device of clause 15A, further comprising a display configured to display decoded video data.

Clause 17A. The device of any of clauses 15A and 16A, wherein the device comprises one or more of a camera, a computer, a mobile device, a broadcast receiver device, or a set-top box.

Clause 18A. A computer-readable storage medium having stored thereon instructions that, when executed, cause one or more processors to perform the method of any one or combination of clauses 1A-14A.

Clause 19A. A device for encoding or decoding video data, the device comprising means for performing the method of any one or combination of clauses 1A-14A.

Clause 1B. A method of encoding or decoding video data, the method comprising: determining one or more chained motion vector prediction (CMVP) candidates for a current block of a current picture, wherein determining the one or more CMVP candidates comprises: determining a source vector; generating an initial CMVP candidate based on the source vector; and scaling the initial CMVP candidate based on the current picture and a reference picture to generate a CMVP candidate of the one or more CMVP candidates; and encoding or decoding the current block based on the one or more CMVP candidates.

Clause 2B. The method of clause 1B, wherein the source vector comprises one of a motion vector of an adjacent block to the current block in the current picture, a motion vector of a non-adjacent block to the current block in the current picture, or a motion vector of a block in another picture.

Clause 3B. The method of any of clauses 1B and 2B, wherein the reference picture is a predetermined picture in one of a first or second reference picture list.

Clause 4B. The method of any of clauses 1B-3B, wherein generating the initial CMVP candidate based on the source vector comprises: accumulating recursively traced motion vectors or block vectors for a trace depth starting from the source vector, wherein each of the traced motion vectors or block vectors is a motion vector or block vector for a block pointed to by a previous motion vector or block vector of the traced motion vectors or block vectors.

Clause 5B. The method of any of clauses 1B-4B, wherein scaling the initial CMVP candidate based on the current picture and the reference picture comprises: determining a first picture order count (POC) value for the current picture; determining a second POC value for the reference picture; determining a third POC value for a picture pointed to by the initial CMVP candidate; determining a first distance based on the first POC value and the third POC value; determining a second distance based on the second POC value and the third POC value; and scaling the initial CMVP candidate based on the first distance and the second distance.

Clause 6B. The method of any of clauses 1B-5B, wherein the source vector is a first source vector, the initial CMVP candidate is a first initial CMVP candidate, the CMVP candidate is a first CMPV candidate, and the reference picture is a first reference picture, the method further comprising: determining a second source vector; generating a second initial CMVP candidate based on the second source vector; and scaling the second CMVP candidate based on the current picture and a second reference picture to generate a second CMVP candidate of the one or more CMVP candidates.

Clause 7B. The method of any of clauses 1B-6B, further comprising: constructing a list of candidate motion vector predictors that includes the one or more CMVP candidates, wherein encoding or decoding the current block comprises encoding or decoding the current block based on the list of candidate motion vector predictors.

Clause 8B. The method of clause 7B, wherein constructing the list of candidate motion vector predictors comprises ordering the list of candidate motion vector predictors based on a template matching cost of the one or more CMVP candidates.

Clause 9B. The method of any of clauses 7B and 8B, wherein encoding or decoding the current block comprises decoding the current block, and wherein decoding the current block comprises: parsing an index into the list of candidate motion vector predictors to identify a motion vector predictor; determining a motion vector for the current block based on the motion vector predictor; determining a prediction signal based on the motion vector; receiving information indicative of a residual between the prediction signal and the current block; and reconstructing the current block based on the residual and the prediction signal.

Clause 10B. The method of any of clauses 7B and 8B, wherein encoding or decoding the current block comprises encoding the current block, and wherein encoding the current block comprises: signaling an index into the list of candidate motion vector predictors to identify a motion vector predictor used for determining a motion vector for the current block; determining a prediction signal based on the motion vector; and signaling information indicative of a residual between a prediction block and the current block.

Clause 11B. A method of encoding or decoding video data, the method comprising: determining one or more chained motion vector prediction (CMVP) candidates for a current block of a current picture, wherein determining the one or more CMVP candidates comprises: determining a source vector; scaling the source vector based on the current picture and a reference picture to generate a scaled source vector; and generating a CMVP candidate of the one or more CMVP candidates based on the scaled source vector; and encoding or decoding the current block based on the one or more CMVP candidates.

Clause 12B. The method of clause 11B, wherein the source vector comprises one of a motion vector of an adjacent block, to the current block, in the current picture, a motion vector of a non-adjacent block, to the current block, in the current picture, or a motion vector of a block in another picture.

Clause 13B. The method of any of clauses 11B and 12B, wherein the reference picture is a predetermined picture in one of a first or second reference picture list.

Clause 14B. The method of any of clauses 11B-13B, wherein generating the CMVP candidate based on the scaled source vector comprises: accumulating recursively traced motion vectors or block vectors for a trace depth starting from the scaled source vector, wherein each of the traced motion vectors or block vectors is a motion vector or block vector for a block pointed to by a previous motion vector or block vector of the traced motion vectors or block vectors.

Clause 15B. The method of any of clauses 11B-14B, wherein scaling the source vector based on the current picture and the reference picture to generate the scaled source vector comprises: determining a first picture order count (POC) value for the current picture; determining a second POC value for the reference picture; determining a third POC value for a picture pointed to by the source vector; determining a first distance based on the first POC value and the third POC value; determining a second distance based on the second POC value and the third POC value; and scaling the source vector based on the first distance and the second distance.

Clause 16B. The method of any of clauses 11B-15B, wherein the reference picture is a first reference picture, wherein the CMVP candidate is a first CMVP candidate, wherein the source vector is a first temporal motion vector predictor (TMVP) and is a motion vector of a block in a different picture than the current picture, the method further comprising: determining a second TMVP that points to a second reference picture identified in a same index in a reference picture list as a third reference picture pointed to by the first TMVP; and determining a second CMVP candidate of the one or more CMVP candidates based on the second TMVP.

Clause 17B. The method of clause 16B, further comprising: determining a first set of template matching costs for the first TMVP and the second TMVP; determining a second set of template matching costs for each of the one or more CMVP candidates; constructing a TMVP list that includes the first TMVP and the second TMVP and is ordered based on the first set of template matching costs; constructing a list of CMVP candidates that includes the first CMVP candidate and the second CMVP candidate and is ordered based on the second set of template matching costs; and constructing a list of candidate motion vector predictors based on the TMVP list and the list of CMVP candidates, wherein encoding or decoding the current block comprises encoding or decoding the current block based on the list of candidate motion vector predictors.

Clause 18B. The method of any of clauses 11B-17B, wherein the source vector is a first source vector, the scaled source vector is a first scaled source vector, the CMVP candidate is a first CMPV candidate, and the reference picture is a first reference picture, the method further comprising: determining a second source vector; scaling the source vector based on the current picture and a second reference picture to generate a second scaled source vector; and generating a second CMVP candidate of the one or more CMVP candidates based on the second scaled source vector.

Clause 19B. The method of any of clauses 11B-18B, further comprising constructing a list of candidate motion vector predictors that includes the one or more CMVP candidates, wherein encoding or decoding the current block comprises decoding the current block, and wherein decoding the current block comprises: parsing an index into the list of candidate motion vector predictors to identify a motion vector predictor; determining a motion vector for the current block based on the motion vector predictor; determining a prediction signal based on the motion vector; receiving information indicative of a residual between the prediction signal and the current block; and reconstructing the current block based on the residual and the prediction signal.

Clause 20B. The method of any of clauses 11B-18B, further comprising constructing a list of candidate motion vector predictors that includes the one or more CMVP candidates, wherein encoding or decoding the current block comprises encoding the current block, and wherein encoding the current block comprises: signaling an index into the list of candidate motion vector predictors to identify a motion vector predictor used for determining a motion vector for the current block; determining a prediction signal based on the motion vector; and signaling information indicative of a residual between a prediction block and the current block.

Clause 21B. A device for encoding or decoding video data, the device comprising: one or more memories configured to store the video data; and processing circuitry coupled to the one or more memories, wherein the processing circuitry is configured to: determine one or more chained motion vector prediction (CMVP) candidates for a current block of a current picture, wherein to determine the one or more CMVP candidates, the processing circuitry is configured to: determine a source vector; generate an initial CMVP candidate based on the source vector; and scale the initial CMVP candidate based on the current picture and a reference picture to generate a CMVP candidate of the one or more CMVP candidates; and encode or decode the current block based on the one or more CMVP candidates.

Clause 22B. The device of clause 21B, wherein the source vector comprises one of a motion vector of an adjacent block, to the current block, in the current picture, a motion vector of a non-adjacent block, to the current block, in the current picture, or a motion vector of a block in another picture.

Clause 23B. The device of any of clauses 21B and 22B, wherein the reference picture is a predetermined picture in one of a first or second reference picture list.

Clause 24B. The device of any of clauses 21B-23B, wherein to generate the initial CMVP candidate based on the source vector, the processing circuitry is configured to: accumulate recursively traced motion vectors or block vectors for a trace depth starting from the source vector, wherein each of the traced motion vectors or block vectors is a motion vector or block vector for a block pointed to by a previous motion vector or block vector of the traced motion vectors or block vectors.

Clause 25B. The device of any of clauses 21B-24B, wherein to scale the initial CMVP candidate based on the current picture and the reference picture, the processing circuitry is configured to: determine a first picture order count (POC) value for the current picture; determine a second POC value for the reference picture; determine a third POC value for a picture pointed to by the initial CMVP candidate; determine a first distance based on the first POC value and the third POC value; determine a second distance based on the second POC value and the third POC value; and scale the initial CMVP candidate based on the first distance and the second distance.

Clause 26B. A device for encoding or decoding video data, the device comprising: one or more memories configured to store the video data; and processing circuitry coupled to the one or more memories, wherein the processing circuitry is configured to: determine one or more chained motion vector prediction (CMVP) candidates for a current block of a current picture, wherein to determine the one or more CMVP candidates, the processing circuitry is configured to: determine a source vector; scale the source vector based on the current picture and a reference picture to generate a scaled source vector; and generate a CMVP candidate of the one or more CMVP candidates based on the scaled source vector; and encode or decode the current block based on the one or more CMVP candidates.

Clause 27B. The device of clause 26B, wherein the source vector comprises one of a motion vector of an adjacent block, to the current block, in the current picture, a motion vector of a non-adjacent block, to the current block, in the current picture, or a motion vector of a block in another picture.

Clause 28B. The device of any of clauses 26B and 27B, wherein the reference picture is a predetermined picture in one of a first or second reference picture list.

Clause 29B. The device of any of clauses 26B-28B, wherein to generate the CMVP candidate based on the scaled source vector, the processing circuitry is configured to: accumulate recursively traced motion vectors or block vectors for a trace depth starting from the scaled source vector, wherein each of the traced motion vectors or block vectors is a motion vector or block vector for a block pointed to by a previous motion vector or block vector of the traced motion vectors or block vectors.

Clause 30B. The device of any of clauses 26B-29B, wherein to scale the source vector based on the current picture and the reference picture to generate the scaled source vector, the processing circuitry is configured to: determine a first picture order count (POC) value for the current picture; determine a second POC value for the reference picture; determine a third POC value for a picture pointed to by the source vector; determine a first distance based on the first POC value and the third POC value; determine a second distance based on the second POC value and the third POC value; and scale the source vector based on the first distance and the second distance.

Clause 31B. A method comprising any one or any combination of the methods of clauses 1B-10B and 11B-20B.

Clause 32B. A computer-readable storage medium storing instructions thereon that when executed cause one or more processors to perform the method of any one of clauses 1B-10B and 11B-20B, including both the methods of clauses 1B-10B and 11B-20B.

Clause 33B. A device for encoding or decoding video data, the device comprising means for performing the method of any of clauses 1B-10B and 11B-20B, including both the methods of clauses 1B-10B and 11B-20B.

Clause 34B. A device of encoding or decoding video data, the device comprising one or more memories; and processing circuitry coupled to the one or more memories and configured to perform the method of any of clauses 1B-10B and 11B-20B, including both the methods of clauses 1B-10B and 11B-20B.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of encoding or decoding video data, the method comprising:
determining one or more chained motion vector prediction (CMVP) candidates for a current block of a current picture, wherein determining the one or more CMVP candidates comprises:
determining a source vector;
generating an initial CMVP candidate based on the source vector; and
scaling the initial CMVP candidate based on the current picture and a reference picture to generate a CMVP candidate of the one or more CMVP candidates; and
encoding or decoding the current block based on the one or more CMVP candidates.

2. The method of claim 1, wherein the source vector comprises one of a motion vector of an adjacent block to the current block in the current picture, a motion vector of a non-adjacent block to the current block in the current picture, or a motion vector of a block in another picture.

3. The method of claim 1, wherein the reference picture is a predetermined picture in one of a first or second reference picture list.

4. The method of claim 1, wherein generating the initial CMVP candidate based on the source vector comprises:
accumulating recursively traced motion vectors or block vectors for a trace depth starting from the source vector, wherein each of the traced motion vectors or block vectors is a motion vector or block vector for a block pointed to by a previous motion vector or block vector of the traced motion vectors or block vectors.

5. The method of claim 1, wherein scaling the initial CMVP candidate based on the current picture and the reference picture comprises:
determining a first picture order count (POC) value for the current picture;
determining a second POC value for the reference picture;
determining a third POC value for a picture pointed to by the initial CMVP candidate;
determining a first distance based on the first POC value and the third POC value;
determining a second distance based on the second POC value and the third POC value; and
scaling the initial CMVP candidate based on the first distance and the second distance.

6. The method of claim 1, wherein the source vector is a first source vector, the initial CMVP candidate is a first initial CMVP candidate, the CMVP candidate is a first CMPV candidate, and the reference picture is a first reference picture, the method further comprising:
determining a second source vector;
generating a second initial CMVP candidate based on the second source vector; and
scaling the second CMVP candidate based on the current picture and a second reference picture to generate a second CMVP candidate of the one or more CMVP candidates.

7. The method of claim 1, further comprising:
constructing a list of candidate motion vector predictors that includes the one or more CMVP candidates,
wherein encoding or decoding the current block comprises encoding or decoding the current block based on the list of candidate motion vector predictors.

8. The method of claim 7, wherein constructing the list of candidate motion vector predictors comprises ordering the list of candidate motion vector predictors based on a template matching cost of the one or more CMVP candidates.

9. The method of claim 7, wherein encoding or decoding the current block comprises decoding the current block, and wherein decoding the current block comprises:
parsing an index into the list of candidate motion vector predictors to identify a motion vector predictor;
determining a motion vector for the current block based on the motion vector predictor;
determining a prediction signal based on the motion vector;
receiving information indicative of a residual between the prediction signal and the current block; and
reconstructing the current block based on the residual and the prediction signal.

10. The method of claim 7, wherein encoding or decoding the current block comprises encoding the current block, and wherein encoding the current block comprises:
signaling an index into the list of candidate motion vector predictors to identify a motion vector predictor used for determining a motion vector for the current block;
determining a prediction signal based on the motion vector; and
signaling information indicative of a residual between a prediction block and the current block.

11. A device for encoding or decoding video data, the device comprising:
one or more memories configured to store the video data; and
processing circuitry coupled to the one or more memories, wherein the processing circuitry is configured to:
determine one or more chained motion vector prediction (CMVP) candidates for a current block of a current picture, wherein to determine the one or more CMVP candidates, the processing circuitry is configured to:
determine a source vector;
generate an initial CMVP candidate based on the source vector; and
scale the initial CMVP candidate based on the current picture and a reference picture to generate a CMVP candidate of the one or more CMVP candidates; and
encode or decode the current block based on the one or more CMVP candidates.

12. The device of claim 11, wherein the source vector comprises one of a motion vector of an adjacent block, to the current block, in the current picture, a motion vector of a non-adjacent block, to the current block, in the current picture, or a motion vector of a block in another picture.

13. The device of claim 11, wherein the reference picture is a predetermined picture in one of a first or second reference picture list.

14. The device of claim 11, wherein to generate the initial CMVP candidate based on the source vector, the processing circuitry is configured to:
accumulate recursively traced motion vectors or block vectors for a trace depth starting from the source vector, wherein each of the traced motion vectors or block vectors is a motion vector or block vector for a block pointed to by a previous motion vector or block vector of the traced motion vectors or block vectors.

15. The device of claim 11, wherein to scale the initial CMVP candidate based on the current picture and the reference picture, the processing circuitry is configured to:
determine a first picture order count (POC) value for the current picture;
determine a second POC value for the reference picture;
determine a third POC value for a picture pointed to by the initial CMVP candidate;
determine a first distance based on the first POC value and the third POC value;
determine a second distance based on the second POC value and the third POC value; and
scale the initial CMVP candidate based on the first distance and the second distance.

16. A device for encoding or decoding video data, the device comprising:
one or more memories configured to store the video data; and
processing circuitry coupled to the one or more memories, wherein the processing circuitry is configured to:
determine one or more chained motion vector prediction (CMVP) candidates for a current block of a current picture, wherein to determine the one or more CMVP candidates, the processing circuitry is configured to:
determine a source vector;
scale the source vector based on the current picture and a reference picture to generate a scaled source vector; and
generate a CMVP candidate of the one or more CMVP candidates based on the scaled source vector; and
encode or decode the current block based on the one or more CMVP candidates.

17. The device of claim 16, wherein the source vector comprises one of a motion vector of an adjacent block, to the current block, in the current picture, a motion vector of a non-adjacent block, to the current block, in the current picture, or a motion vector of a block in another picture.

18. The device of claim 16, wherein the reference picture is a predetermined picture in one of a first or second reference picture list.

19. The device of claim 16, wherein to generate the CMVP candidate based on the scaled source vector, the processing circuitry is configured to:
accumulate recursively traced motion vectors or block vectors for a trace depth starting from the scaled source vector, wherein each of the traced motion vectors or block vectors is a motion vector or block vector for a block pointed to by a previous motion vector or block vector of the traced motion vectors or block vectors.

20. The device of claim 16, wherein to scale the source vector based on the current picture and the reference picture to generate the scaled source vector, the processing circuitry is configured to:
determine a first picture order count (POC) value for the current picture;
determine a second POC value for the reference picture;
determine a third POC value for a picture pointed to by the source vector;
determine a first distance based on the first POC value and the third POC value;
determine a second distance based on the second POC value and the third POC value; and
scale the source vector based on the first distance and the second distance.
